(19) United States
(12) Patent Application Publication
(10) Pub. No.: US 2018/0320043 A1
(43) Pub. Date: Nov. 8, 2018

(54) FILLING METHOD FOR MIXED REFRIGERANT INCLUDING TRIFLUOROETHYLENE

(71) Applicant: AGC INC., Chiyoda-ku (JP)

(72) Inventors: Mai TASAKA, Tokyo (JP); Masato FUKUSHIMA, Tokyo (JP); Hiroki HAYAMIZU, Tokyo (JP)

(73) Assignee: AGC INC., Chiyoda-ku (JP)

(21) Appl. No.: 16/037,399

(22) Filed: Jul. 17, 2018

Related U.S. Application Data
(63) Continuation of application No. PCT/JP2017/001132, filed on Jan. 13, 2017.

(30) Foreign Application Priority Data
Jan. 18, 2016 (JP) 2016-007438

(51) Int. Cl. C09K 5/04

(52) U.S. Cl. CPC C09K 5/045; C09K 2205/34; C09K 2205/22; C09K 2205/122

(57) ABSTRACT

The present invention relates to a filling method for a mixed refrigerant, in which in a case of transferring and filling a mixed refrigerant that contains trifluoroethylene and 2,3,3,3-tetrafluoropropene and in which the trifluoroethylene is present in an amount of 10 to 92 mass % in a liquid phase, with respect to a total 100 mass % of the trifluoroethylene and the 2,3,3,3-tetrafluoropropene, in a liquid from a feeding container to a target container and equipment, a liquid phase mixing ratio (initial composition) of the trifluoroethylene in the mixed refrigerant in the feeding container immediately before the transferring and filling is set to x+y_{P} (minimum value) to x % (target upper limit composition).

### TECHNICAL FIELD

The present invention relates to a filling method for a mixed refrigerant containing trifluoroethylene.

### BACKGROUND ART

Heretofore, as a working fluid for heat cycle such as a refrigerant for a refrigerator, a refrigerant for an air-conditioning apparatus, a working fluid for power generation system (such as exhaust heat recovery power generation), a working fluid for a latent heat transport apparatus (such as a heat pipe) or a secondary cooling fluid, a chlorofluorocarbon (CFC) such as chlorotrifluoromethane or dichlorodifluoromethane or a hydrochlorofluorocarbon (HCFC) such as chlorodifluoromethane has been used. However, influences of CFCs and HCFCs over the ozone layer in the stratosphere have been pointed out, and their use is regulated at present.

Under the above conditions, as a working fluid for heat cycle, a hydrofluorocarbon (HFC) which has less influence over the ozone layer, such as difluoromethane (HFC-32), tetrafluoroethane, or pentafluoroethane (HFC-125) has been used, instead of CFCs and HCFCs. For example, R410A (a pseudoazeotropic mixed refrigerant of HFC-32 and HFC-125 in a mass ratio of 1:1) is a refrigerant which has been widely used. However, it is pointed out that HFCs may cause global warming.

R410A has been widely used for a common air-conditioning apparatus such as a so-called package air-conditioner or room air-conditioner, due to its high refrigerating capacity. However, it has a global warming potential (GWP) of so high as 2,088, and accordingly development of a working fluid with low GWP has been desired.

Accordingly, in recent years, a hydrofluoroolefin (HFO), that is, a HFC having a carbon-carbon double bond is expected, which is a working fluid having less influence over the ozone layer and having less influence over global warming, since the carbon-carbon double bond is likely to be decomposed by OH radicals in the air.

In the present specification, a saturated HFC will be referred to as a HFC and distinguished from a HFO unless otherwise specified. In addition, a HFC may be referred to as a saturated hydrofluorocarbon in some cases. Furthermore, in the present specification, abbreviated names of halogenated hydrocarbon compounds such as HFCs and HFOs are described in brackets after the compound names, and in the present specification, the abbreviated names are employed instead of the compound names as the case requires.

As a working fluid employing such HFO, for example, PTL 1 discloses a technique relating to a working fluid using trifluoroethylene (HFO-1123) which has the above properties and with which excellent cycle performance will be obtained. PTL 1 also discloses an attempt to obtain a working fluid containing HFO-1123 and various HFCs in combination for the purpose of increasing the flame retardancy, cycle performance, and the like of the working fluid.

Further, HFO, HFC, or the like is known as a reactive refrigerant that undergoes self-decomposition with an ignition source at high temperature or high pressure, in a case of being used alone. Therefore, NPL 1 discloses an attempt to suppress self-decomposition reaction by mixing trifluoroethylene (HFO-1123) or the like with another component such as vinylidene fluoride to form a mixture having a lowered content of HFO-1123.

Further, PTL 2 proposes to use HFO-1123 as a single refrigerant for a heat cycle system, as well as a mixed refrigerant of HFO-1123 and HFC-32, or HFO-1123 and HFO-1234yf.

### CITATION LIST

### Patent Literature

PTL 1: International Publication WO 2012/157764
PTL 2: International Publication WO 2015/136703
PTL 3: JP-A-10-197108
PTL 4: Japanese Patent No. 3186065
PTL 5: International Publication WO 2015/133548

### Non Patent Literature

NPL 1: Combustion, Explosion, and Shock Waves, Vol. 42, No 2, pp. 140 to 143, 2006

### SUMMARY OF INVENTION

### Technical Problem

However, since most of mixtures of HFO and HFC is a non-azeotropic mixture, compositional variations occur in a case where a phase changes like evaporation and condensation. This is because components of low boiling point tend to evaporate and components of high boiling point tend to condense. This tendency is large in a case of evaporation, that is, in a case of a phase change from liquid to vapor, and is particularly significant as constituent components of a mixture have a larger boiling point difference. Accordingly, in a case of transferring such a non-azeotropic mixture from a container to another container, it is usual to extract it from a liquid side so as not to cause a phase change.

However, as described in PTLs 3 and 4, even in a case of being extracted from the liquid side, in a case where constituent components of a mixture have a large boiling point difference, compositional changes of several mass % occur. This is because evaporation of a low boiling point component in a liquid phase occurs due to pressure reduction caused by extraction and increase in a space of a gas phase part. Such compositional changes of several mass % not only cause a large change in refrigerant performances, to decrease capacity and efficiency thereof, but also greatly affect safety of the refrigerant such as combustibility.

In particular, although HFC-32 (difluoromethane), which is highly likely to be used as a mixed refrigerant with HFO-1123, has a very high refrigerating capacity, HFC-32 has a boiling point difference of about 5° C. with HFO-1123. Thus, compositional changes may occur in a case of carrying out transferring and filling from a supply side container such as a cylinder or a tank lorry to a refrigeration air-conditioning apparatus or another cylinder. In addition, in terms of performances as well as quality assurance of a mixed refrigerant, it is important to keep compositional changes within a set tolerance of the mixed refrigerant.

For example, in a case where such compositional changes occur, refrigerating capacity and refrigerant capability, such as COP, which are anticipated with an intended composition, cannot be guaranteed. Therefore, it becomes important to keep this compositional variation rate as small as possible.

For example, PTL 5 describes a filling method aimed at keeping compositional changes of a mixed refrigerant containing trans-1,3,3,3-tetrafluoropropene within an allowable range.

However, compositional variations greatly vary depending on a type and compositional ratio of a non-azeotropic refrigerant, and it is difficult to forecast a range of the compositional variations beforehand without any actual measurement.

Accordingly, an object of the present invention is to provide a filling method for a mixed refrigerant capable of keeping compositional changes during transferring and filling of a non-azeotropic mixed refrigerant composed of HFO-1123 and HFO-1234yf within an allowable range of refrigerant performances.

### Solution to Problem

In order to achieve the above object, according to one aspect of the present invention, there is provided a filling method for a mixed refrigerant, in which in a case of transferring and filling a mixed refrigerant that contains trifluoroethylene and 2,3,3,3-tetrafluoropropene and in which the trifluoroethylene is present in an amount of 10 to 92 mass %, in a liquid phase, with respect to a total 100 mass % of the trifluoroethylene and the 2,3,3,3-tetrafluoropropene, in a liquid from a feeding container to a target container and equipment, in order to keep a liquid phase mixing ratio of the trifluoroethylene in the mixed refrigerant in the feeding container from start of the transferring and filling until completion thereof within a range from a target upper limit composition (x) of the trifluoroethylene to the target upper limit composition (x)−4.0 mass % (target lower limit composition), a liquid phase mixing ratio (initial composition) of the trifluoroethylene in the mixed refrigerant in the feeding container immediately before the transferring and filling is set to x+y_{P} (minimum value) to x % (target upper limit composition).

a: Initial filling amount (mass %) in feeding container

x: Target upper limit composition (10≤x≤92, except for a range where y_{P}>0).

y_{P}: Lower limit value of a gap between target upper limit composition and initial composition, which is a value represented by Expression (A).

[Math. 1]

1000y_{P}=L_{P}x³+M_{P}x²+N_{P}x+P_{P}

L_{P}=−0.00003a+0.0211

M_{P}=0.0119a−5.313

N_{P}=−0.9678a+334.84

P_{P}=2.979a−4879.3 (A)

According to another aspect of the present invention, there is provided a filling method for a mixed refrigerant, in which in a case of transferring and filling a mixed refrigerant that contains trifluoroethylene and 2,3,3,3-tetrafluoropropene and in which the trifluoroethylene is present in an amount of 10 to 91.5 mass %, in a liquid phase, with respect to a total 100 mass % of the trifluoroethylene and the 2,3,3,3-tetrafluoropropene, in a liquid from a feeding container to a target container and equipment, in order to keep a liquid phase mixing ratio of the trifluoroethylene in the mixed refrigerant in the feeding container from start of the transferring and filling until completion thereof within a range from a target upper limit composition (x) of the trifluoroethylene to the target upper limit composition (x)−3.0 mass % (target lower limit composition), a liquid phase mixing ratio (initial composition) of the trifluoroethylene in the mixed refrigerant in the feeding container immediately before the transferring and filling is set to x+y_{Q} (minimum value) to x % (target upper limit composition).

a: Initial filling amount (mass %) in feeding container

x: Target upper limit composition (10≤x≤91.5, except for a range where y_{Q}>0).

y_{Q}: Lower limit value of a gap between target upper limit composition and initial composition, which is a value represented by Expression (B).

[Math. 2]

1000y_{Q}=L_{Q}x³+M_{Q}x²+N_{Q}x+P_{Q}

L_{Q}=−0.0001a−0.0276

M_{Q}=0.0262a−6.2574

N_{Q}=−1.5203a+364.04

P_{Q}=5.928a−3797.8 (B)

According to still another aspect of the present invention, there is provided a filling method for a mixed refrigerant, in which in a case of transferring and filling a mixed refrigerant that contains trifluoroethylene and 2,3,3,3-tetrafluoropropene and in which the trifluoroethylene is present in an amount of 10 to 91 mass %, in a liquid phase, with respect to a total 100 mass % of the trifluoroethylene and the 2,3,3,3-tetrafluoropropene, in a liquid from a feeding container to a target container and equipment, in order to keep a liquid phase mixing ratio of the trifluoroethylene in the mixed refrigerant in the feeding container from start of the transferring and filling until completion thereof within a range from a target upper limit composition (x) of the trifluoroethylene to the target upper limit composition (x)−2.0 mass % (target lower limit composition), a liquid phase mixing ratio (initial composition) of the trifluoroethylene in the mixed refrigerant in the feeding container immediately before the transferring and filling is set to x+y_{R} (minimum value) to x % (target upper limit composition).

a: Initial filling amount (mass %) in feeding container

x: Target upper limit composition (10≤x≤91, except for a range where y_{R}>0).

y_{R}: Lower limit value of a gap between target upper limit composition and initial composition, which is a value represented by Expression (C).

[Math. 3]

1000y_{R}=L_{R}x³+M_{R}x²+N_{R}x+P_{R}

L_{R}=−0.00005a+0.0223

M_{R}=0.0159a−5.5003

N_{R}=−1.0799a+324.91

P_{R}=2.771a−2333.7 (C)

### Advantageous Effects of Invention

According to the present invention, it is possible to keep compositional changes during transferring and filling a non-azeotropic mixed refrigerant composed of HFO-1123 and HFO-1234yf within an allowable range of refrigerant performances.

### DESCRIPTION OF EMBODIMENTS

Hereinafter, embodiments for carrying out the present invention will be described.

In order to solve a problem of compositional changes occurring in a case of transferring and filling a non-azeotropic mixture composed of two types of liquefied gases having different boiling points stored in a closed container from a liquid side to another container, the present inventors have made extensive studies on a filling method for liquefied gas.

That is, the present invention provides a filling method for a non-azeotropic mixed refrigerant composed of HFO-1123 and HFO-1234yf as described below.

In the filling method for a mixed refrigerant of the present invention, in a case of transferring and filling a HFO-1123/HFO-1234yf mixed refrigerant, which is a non-azeotropic refrigerant and has a composition with HFO-1123 being 10 to 92 mass % in a liquid phase, from a feeding container to a target container and equipment, a liquid phase mixing ratio of HFO-1123 in the feeding container before the transferring and filling is set within a specific range.

Descriptions will be made with respect to a mixing ratio of the mixed refrigerant in the feeding container before carrying out transferring and filling, in a case of transferring and filling the mixed refrigerant from the feeding container to the target container and equipment such that maximum filling (filling amount of 100 mass %) of the mixed refrigerant into the container is achieved.

The above-mentioned filling amount of 100 mass % refers to a maximum filling amount that can be filled in a container and is defined by the International Law on Transportation and the Japan's High Pressure Gas Safety Act. According to the Japan's High Pressure Gas Safety Act, it is calculated as follows.
SG=V/C
G: Mass of fluorocarbon (kg)
V: Internal volume of container (L)
C: Constant depending on type of fluorocarbon

In this case, a filling constant C is defined in Japan as a value obtained by dividing 1.05 by a specific gravity of gas in question at 48° C. In addition, in a case involving exports, according to the International Law, this filling constant C is defined as a value obtained by dividing 1.05 by a specific gravity of gas in question at 65° C. in a case of passing through tropical regions, and is defined as a value obtained by dividing 1.05 by a specific gravity of gas in question at 45° C. for other regions except the tropics.

In a case of transferring and filling the HFO-1123/HFO-1234yf mixed refrigerant from the feeding container to the target container and equipment, as an initial filling amount of the feeding container is smaller, compositional changes of a liquid phase mixing ratio of HFO-1123 in the mixed refrigerant in the feeding container from start of the transferring and filling until completion thereof become smaller.

Hereinafter, a value obtained by dividing 1.05 by a specific gravity of gas in question at 45° C. is adopted as a filling constant, and the calculated value is set to a filling amount of 100%.

Hereinafter, embodiments of a specific filling method will be described according to mass % difference between a target upper limit composition and a target lower limit composition.

### (1) Filling Method in Case where Difference Between Target Upper Limit Composition and Target Lower Limit Composition is 4 Mass %

In a case of transferring and filling a mixed refrigerant in a liquid from a feeding container to a target container and equipment, a mixing ratio of the mixed refrigerant in the feeding container before the transferring and filling will be described so as to keep the liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition).

The above-mentioned “target upper limit composition: (x)” is a maximum value that allows composition of HFO-1123 in the entire composition (liquid phase+gas phase) of the HFO-1123/HFO-1234yf mixed refrigerant, which is required in the target container and equipment, to be within the range. x (mass %) is a numerical value within a range of 10≤x≤92. The above-mentioned “target lower limit composition: (x)−4 mass %” is a minimum value that allows composition of HFO-1123 in the entire composition (liquid phase+gas phase) of the HFO-1123/HFO-1234yf mixed refrigerant, which is required in the target container and equipment, to be within the range.

### (1-1) Filling Method in Case where Difference Between Target Upper Limit Composition and Target Lower Limit Composition is 4 Mass %

In the filling method for a mixed refrigerant of the present invention in a case where a filling amount of the mixed refrigerant to a container is appropriately adjusted, in a case of transferring and filling a mixed refrigerant that contains HFO-1123 and HFO-1234yf in which HFO-1123 is present in an amount of 10 to 92 mass %, in a liquid phase, with respect to a total 100 mass % of HFO-1123 and HFO-1234yf, in a liquid from a feeding container to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition), a liquid phase mixing ratio (initial composition) of HFO-1123 in the mixed refrigerant in the feeding container immediately before carrying out the transferring and filling is set to x+y_{P} (minimum value) to x % (target upper limit composition).

a: Initial filling amount (mass %) in feeding container

x: Target upper limit composition (mass %, 10≤x≤92, except for a range where y_{P}>0).

y_{P}: Lower limit value of a gap between target upper limit composition and initial composition, which is a value represented by Expression (1).

[Math. 4]

1000y_{P}=L_{P}x³+M_{P}x²+N_{P}x+P_{P}

L_{P}=−0.0000a+0.0211

M_{P}=0.0119a−5.313

N_{P}=−0.9678a+334.84

P_{P}2.979a−4879.3 (1)

According to the filling method for a mixed refrigerant of the present invention, even in a case where a filling amount of the mixed refrigerant in the feeding container is 100 mass % of a maximum filling amount, by setting a liquid phase mixing ratio of HFO-1123 in the feeding container before carrying out transferring and filling to a specific range, it is possible to keep compositional changes in a target container and equipment with a range from the target upper limit composition (x)−4.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling.

Further, the value of a is usually set within a range of 60≤a≤100.

Hereinafter, as an example of the transferring and filling method, a case where a handling temperature during transferring and filling is 40° C. is shown. For example, in the Japan's High Pressure Gas Safety Act, since handling of containers at 40° C. or higher is prohibited, a handling temperature during transferring and filling in Japan is 0° C. to 40° C. As a temperature during transferring and filling (during handling) is higher, compositional changes due to the transferring and filling from start of the transferring and filling until completion thereof become larger in a case of carrying out the transferring and filling in a liquid from the feeding container to the target container and equipment. Therefore, conditions of transferring and filling at a handling temperature of 40° C. are applied, and thus such conditions are also applicable to a handling temperature of 0° C. to 40° C.

Further, regarding also a filling amount in the feeding container, as an initial filling amount is smaller, a range of compositional changes due to the transferring and filling from start of the transferring and filling until completion thereof become smaller in a case of carrying out transferring and filling in a liquid from the feeding container to the target container and equipment. Therefore, a mathematical expression satisfying a filling method in which an initial filling amount is a mass % also satisfies a filling method in which the initial filling amount is a mass % or less. For example, a mathematical expression satisfying a filling method in which an initial filling amount is 100 mass % also satisfies a filling method in which the initial filling amount is 100 to 0 mass %. A mathematical expression satisfying a filling method in which an initial filling amount is 90 mass % also satisfies a filling method in which the initial filling amount is 90 to 0 mass %. A mathematical expression satisfying a filling method in which an initial filling amount is 80 mass % also satisfies a filling method in which the initial filling amount is 80 to 0 mass %. A mathematical expression satisfying a filling method in which an initial filling amount is 70 mass % also satisfies a filling method in which the initial filling amount is 70 to 0 mass %. A mathematical expression satisfying a filling method in which an initial filling amount is 60 mass % also satisfies a filling method in which the initial filling amount is 60 to 0 mass %.

Liquid Phase Mixing Ratio of HFO-1123 in Mixed Refrigerant in Feeding Container

In the present invention, in order to be kept within a range from the target upper limit composition (x) of HFO-1123−4.0 mass % (target lower limit composition) to the target upper limit composition (x), a liquid phase mixing ratio (initial composition) of HFO-1123 in the mixed refrigerant in the feeding container immediately before transferring and filling is set to x+y_{P} (minimum value) to x % (target upper limit composition).

x is a target upper limit composition, and y_{P} is a gap between the target upper limit composition (x) and the initial composition. x+y₁ represents a minimum value of the liquid phase mixing ratio (initial composition) of HFO-1123 in the mixed refrigerant in the feeding container.

A difference between the target upper limit composition and the target lower limit composition is called a composition tolerance. The composition tolerance is determined in a case where a composition of a mixed refrigerant is registered in ASHRAE Standard 2013 (Designation and Safety Classification of Refrigerants) or the like.

In a mixed refrigerant containing HFO-1123 and HFO-1234yf, a case where a mixing ratio of HFO-1123 and HFO-1234yf is, for example, 50:50 (mass %) will be described. In this mixed refrigerant (HFO-1123/HFO-1234yf), in a case where a composition tolerance is set to +2.0, −2.0/+2.0, −2.0, a target upper limit composition of HFO-1123 is 52.0 mass %, and a target lower limit composition of HFO-1123 is 48.0 mass %. Thus, the mixed refrigerant has a difference of 4 mass % between the target upper limit composition and the target lower limit composition.

### (1-2) Filling Method in Case where Filling Amount of Mixed Refrigerant to Container is 100 Mass % of Maximum Filling Amount

A case where a filling amount of a mixed refrigerant to a container is 100 mass % of a maximum filling amount, and a liquid phase mixing ratio of HFO-1123 in the mixed refrigerant in a feeding container allows HFO-1123 to be kept within a range from the target upper limit composition (x)−4.0 mass % (target lower limit composition) to the target upper limit composition (x) will be described.

In the filling method for a mixed refrigerant of the present invention, in a case of transferring and filling a mixed refrigerant that contains HFO-1123 and HFO-1234yf in which HFO-1123 is present in an amount of 10 to 92 mass %, in a liquid phase, with respect to a total 100 mass % of HFO-1123 and HFO-1234yf, in a liquid from a feeding container, which is filled in an amount of 100 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition), a liquid phase mixing ratio (initial composition) of HFO-1123 in the mixed refrigerant in the feeding container immediately before the transferring and filling is preferably set to x+y_{P1} (minimum value) to x % (target upper limit composition).

The above-mentioned x is a target upper limit composition (where x satisfies 10≤x≤92).

y_{P1} is a lower limit value of a gap between the target upper limit composition and the initial composition and is a value represented by Expression (2).

[Math. 5]

1000y_{P1}=0.0189x³−4.2359x²+245.39x−4637.1 (2)

In the present invention, from Expression (2), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−3.2 mass % to x mass %, it is possible to keep compositional changes in the target container and equipment with a range from the target upper limit composition (x)−4.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−4.0 mass % (target lower limit composition) to the target upper limit composition (x) until completion of the transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −3.2 mass % with respect to the target upper limit composition, it is possible to keep the liquid phase mixing ratio of HFO-1123 within a range from the target upper limit composition (x)−4.0 mass % (target lower limit composition) to the target upper limit composition (x) until completion of the transferring and filling.

### (1-3) Filling Method in Case where Filling Amount of Mixed Refrigerant to Container is 90 Mass % of Maximum Filling Amount

A case where a filling amount of a mixed refrigerant to a container is 90 mass % of a maximum filling amount, and a liquid phase mixing ratio of HFO-1123 in the mixed refrigerant in a feeding container allows HFO-1123 to be kept within a range from the target upper limit composition (x)−4.0 mass % (target lower limit composition) to the target upper limit composition (x) will be described.

In the filling method for a mixed refrigerant of the present invention, in a case of transferring and filling a mixed refrigerant that contains HFO-1123 and HFO-1234yf in which HFO-1123 is present in an amount of 10 to 92 mass %, in a liquid phase, with respect to a total 100 mass % of HFO-1123 and HFO-1234yf, in a liquid from a feeding container, which is filled in an amount of 90 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition), a liquid phase mixing ratio (initial composition) of HFO-1123 in the mixed refrigerant in the feeding container immediately before the transferring and filling is preferably set to x+y_{P2} to x mass % (target upper limit composition).

The above-mentioned x is a target upper limit composition (where x satisfies 10≤x≤92).

y_{P2} is a lower limit value of a gap between the target upper limit composition and the initial composition and is a value represented by Expression (3).

[Math. 6]

1000y_{P2}=0.0184x³−4.1549x²−242.21x−4555.6 (3)

In the present invention, from Expression (3), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−3.2 mass % to x mass %, it is possible to keep compositional changes in the target container and equipment with a range from the target upper limit composition (x)−4.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−4.0 mass % (target lower limit composition) to the target upper limit composition (x) until completion of the transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −3.2 mass % with respect to the target upper limit composition, it is possible to keep the liquid phase mixing ratio of HFO-1123 within a range from the target upper limit composition (x)−4.0 mass % (target lower limit composition) to the target upper limit composition (x) until completion of the transferring and filling.

### (1-4) Filling Method in Case where Filling Amount of Mixed Refrigerant to Container is 80 Mass % of Maximum Filling Amount

A case where a filling amount of a mixed refrigerant to a container is 80 mass % of a maximum filling amount, and a liquid phase mixing ratio of HFO-1123 in the mixed refrigerant in a feeding container allows HFO-1123 to be kept within a range from the target upper limit composition (x)−4.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 92 mass %, in a liquid phase, with respect to a total 100 mass % of HFO-1123 and HFO-1234yf, in a liquid from a feeding container, which is filled in an amount of 80 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition), a liquid phase mixing ratio (initial composition) of HFO-1123 in the mixed refrigerant in the feeding container immediately before the transferring and filling is preferably set to x+y_{P3} to x mass %.

The above-mentioned x is a target upper limit composition (where x satisfies 10≤x≤92).

y_{P3} is a lower limit value of a gap between the target upper limit composition and the initial composition and is a value represented by Expression (4).

[Math. 7]

1000y_{P3}=085x³−4.2481x²+250.46x−457.7 (4)

In the present invention, from Expression (4), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−3.2 mass % to x mass %, it is possible to keep compositional changes in the target container and equipment with a range from the target upper limit composition (x)−4.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−4.0 mass % (target lower limit composition) to the target upper limit composition (x) until completion of the transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −3.2 mass % with respect to the target upper limit composition, it is possible to keep the liquid phase mixing ratio of HFO-1123 within a range from the target upper limit composition (x)−4.0 mass % (target lower limit composition) to the target upper limit composition (x) until completion of the transferring and filling.

### (1-5) Filling Method in Case where Filling Amount of Mixed Refrigerant to Container is 70 Mass % of Maximum Filling Amount

A case where a filling amount of a mixed refrigerant to a container is 70 mass % of a maximum filling amount, and a liquid phase mixing ratio of HFO-1123 in the mixed refrigerant in a feeding container allows HFO-1123 to be kept within a range from the target upper limit composition (x)−4.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 92 mass %, in a liquid phase, with respect to a total 100 mass % of HFO-1123 and HFO-1234yf, in a liquid from a feeding container, which is filled in an amount of 70 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition), a liquid phase mixing ratio (initial composition) of HFO-1123 in the mixed refrigerant in the feeding container immediately before the transferring and filling is preferably set to x+y_{P4} to x mass %.

The above-mentioned x is a target upper limit composition (where x satisfies 10≤x≤92).

y_{P4} is a lower limit value of a gap between the target upper limit composition and the initial composition and is a value represented by Expression (5).

1000y_{P4}=0.0196x³−4.5196x²+268.29x−4736.9(5) [Math. 8]

In the present invention, from Expression (5), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−3.1 mass % to x mass %, it is possible to keep compositional changes in the target container and equipment with a range from the target upper limit composition (x)−4.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−4.0 mass % (target lower limit composition) to the target upper limit composition (x) until completion of the transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −3.1 mass % with respect to the target upper limit composition, it is possible to keep the liquid phase mixing ratio of HFO-1123 within a range from the target upper limit composition (x)−4.0 mass % (target lower limit composition) to the target upper limit composition (x) until completion of the transferring and filling.

### (1-6) Filling Method in Case where Filling Amount of Mixed Refrigerant to Container is 60 Mass % of Maximum Filling Amount

A case where a filling amount of a mixed refrigerant to a container is 60 mass % of a maximum filling amount, and a liquid phase mixing ratio of HFO-1123 in the mixed refrigerant in a feeding container allows HFO-1123 to be kept within a range from the target upper limit composition (x)−4.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 28.7 mass % or 54.0 to 92 mass %, in a liquid phase, with respect to a total 100 mass % of HFO-1123 and HFO-1234yf, in a liquid from a feeding container, which is filled in an amount of 60 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−4.0 mass % (target lower limit composition), a liquid phase mixing ratio (initial composition) of HFO-1123 in the mixed refrigerant in the feeding container immediately before the transferring and filling is preferably set to x+y_{P5} to x mass %.

The above-mentioned x is a target upper limit composition (where x satisfies 10≤x≤28.7 or 54.0≤x≤92).

y_{P5} is a lower limit value of a gap between the target upper limit composition and the initial composition and is a value represented by Expression (6).

[Math. 9]

1000y_{P8}=0.196x³−4.6483x²+280.74x−4695.4 (6)

In the present invention, from Expression (6), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−3.0 mass % to x mass %, it is possible to keep compositional changes in the target container and equipment with a range from the target upper limit composition (x)−4.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−4.0 mass % (target lower limit composition) to the target upper limit composition (x) until completion of the transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −3.0 mass % with respect to the target upper limit composition, it is possible to keep the liquid phase mixing ratio of HFO-1123 within a range from the target upper limit composition (x)−4.0 mass % (target lower limit composition) to the target upper limit composition (x) until completion of the transferring and filling.

### (1-7) Filling Method for Non-Azeotropic Mixed Refrigerant Containing HFO-1123 and HFO-1234yf

A filling method that allows a non-azeotropic mixed refrigerant composed of HFO-1123 and HFO-1234yf to be kept within a range from the target upper limit composition (x) of HFO-1123−4.0 mass % (target lower limit composition) to the target upper limit composition (x) will be described.

Expression (1) can be derived from Expressions (2) to (6). Based on values of coefficients of Expressions (2) to (6), Lp to Pp of Expression (1) can be derived from the target upper limit composition (x) with respect to the initial filling amount (a mass %).

In the filling method for a mixed refrigerant of the present invention, in a case of transferring and filling a mixed refrigerant that contains HFO-1123 and HFO-1234yf in which HFO-1123 is present in an amount of 10 to 92 mass %, in a liquid phase, with respect to a total 100 mass % of HFO-1123 and HFO-1234yf, in a liquid from a feeding container to a target container and equipment, in order to keep a liquid phase mixing ratio of HFO-1123 in the mixed refrigerant in the feeding container from start of the transferring and filling until completion thereof within a range from the target upper limit composition (x) of HFO-1123−4.0 mass % (target lower limit composition) to a target upper limit composition (x), a liquid phase mixing ratio (initial composition) of HFO-1123 in the mixed refrigerant in the feeding container immediately before the transferring and filling is set to x+y_{P}(minimum value) to x (maximum value) mass %.

a: Initial filling amount (mass %) in feeding container

x: Target upper limit composition (mass %, 10≤x≤92, except for a range where y_{P}>0).

y_{P}: Lower limit value of a gap between target upper limit composition and initial composition, which is a value represented by Expression (1).

[Math. 10]

1000y_{P}=L_{P}x³+M_{P}x²+N_{P}x+P_{P}

L_{P}=−0.00003a+0.0211

M_{P}=0.0119a−5.313

N_{P}=−0.9678a−334.84

P_{P}=2.979a−4879.3 (1)

### (2) Filling Method in Case where Difference Between Target Upper Limit Composition and Target Lower Limit Composition is 3 Mass %

In a case of transferring and filling a mixed refrigerant in a liquid from a feeding container to a target container and equipment, a mixing ratio of the mixed refrigerant in the feeding container before the transferring and filling will be described so as to keep the liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition).

The above-mentioned “target upper limit composition: (x)” is a maximum value that allows composition of HFO-1123 in the entire composition (liquid phase+gas phase) of the HFO-1123/HFO-1234yf mixed refrigerant, which is required in the target container and equipment, to be within the range. x (mass %) is a numerical value within a range of 10≤x≤91.5. The above-mentioned “target lower limit composition: (x)−3 mass %” is a minimum value that allows composition of HFO-1123 in the entire composition (liquid phase+gas phase) of the HFO-1123/HFO-1234yf mixed refrigerant, which is required in the target container and equipment, to be within the range.

### (2-1) Filling Method in Case where Difference Between Target Upper Limit Composition and Target Lower Limit Composition is 3 Mass %

In the filling method for a mixed refrigerant of the present invention in a case where a filling amount of the mixed refrigerant to a container is appropriately adjusted, in a case of transferring and filling a mixed refrigerant, that contains HFO-1123 and HFO-1234yf in which HFO-1123 is present in an amount of 10 to 91.5 mass %, in a liquid phase, with respect to a total 100 mass % of HFO-1123 and HFO-1234yf, in a liquid from a feeding container to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition), a liquid phase mixing ratio (initial composition) of HFO-1123 in the mixed refrigerant in the feeding container immediately before carrying out the transferring and filling is set to x+y_{Q} (minimum value) to x mass % (maximum value).

a: Initial filling amount (mass %) in feeding container

x: Target upper limit composition (mass %, 10≤x≤91.5, except for a range where y_{Q}>0).

y_{Q}: Lower limit value of a gap between target upper limit composition and initial composition, which is a value represented by Expression (7).

[Math. 11]

1000y_{Q}=L_{Q}x³+M_{Q}x²+N_{Q}x+P_{Q}

L_{Q}=−0.0001a+0.0276

M_{Q}=0.0262a−6.2574

N_{Q}=−1.5203a+364.04

P_{Q}=5.928a−3797.8 (7)

According to the filling method for a mixed refrigerant of the present invention, even in a case where a filling amount of the mixed refrigerant in the feeding container is 100 mass % of a maximum filling amount, by setting a liquid phase mixing ratio of HFO-1123 in the feeding container before carrying out transferring and filling to a specific range, it is possible to keep compositional changes in a target container and equipment with a range from the target upper limit composition (x)−3.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling.

Further, the value of a is usually set within a range of 60≤a≤100.

Hereinafter, as an example of the transferring and filling method, a case where a handling temperature during transferring and filling is 40° C. is shown. For example, in the Japan's High Pressure Gas Safety Act, since handling of containers at 40° C. or higher is prohibited, a handling temperature during transferring and filling in Japan is, in particular, 0° C. to 40° C. As a temperature during transferring and filling (during handling) is higher, compositional changes due to the transferring and filling from start of the transferring and filling until completion thereof become larger in a case of carrying out the transferring and filling in a liquid from the feeding container to the target container and equipment. Therefore, conditions of transferring and filling at a handling temperature of 40° C. are applied, and thus such conditions are also applicable to a handling temperature of 0° C. to 40° C.

Further, regarding also a filling amount in the feeding container, as an initial filling amount is smaller, a range of compositional changes due to the transferring and filling from start of the transferring and filling until completion thereof become smaller in a case of carrying out transferring and filling in a liquid from the feeding container to the target container and equipment. Therefore, a mathematical expression satisfying a filling method in which an initial filling amount is a mass % also satisfies a filling method in which the initial filling amount is a mass % or less. For example, a mathematical expression satisfying a filling method in which an initial filling amount is 100 mass % also satisfies a filling method in which the initial filling amount is 100 to 0 mass %. A mathematical expression satisfying a filling method in which an initial filling amount is 90 mass % also satisfies a filling method in which the initial filling amount is 90 to 0 mass %. A mathematical expression satisfying a filling method in which an initial filling amount is 80 mass % also satisfies a filling method in which the initial filling amount is 80 to 0 mass %. A mathematical expression satisfying a filling method in which an initial filling amount is 70 mass % also satisfies a filling method in which the initial filling amount is 70 to 0 mass %. A mathematical expression satisfying a filling method in which an initial filling amount is 60 mass % also satisfies a filling method in which the initial filling amount is 60 to 0 mass %.

Liquid Phase Mixing Ratio of HFO-1123 in Mixed Refrigerant in Feeding Container

In the present invention, in order to be kept within a range from the target upper limit composition (x) of HFO-1123-3.0 mass % (target lower limit composition) to the target upper limit composition (x), a liquid phase mixing ratio (initial composition) of HFO-1123 in the mixed refrigerant in the feeding container immediately before transferring and filling is set to x+y_{Q} (minimum value) to x % (target upper limit composition).

x is a target upper limit composition, and y_{Q} is a gap between the target upper limit composition (x) and the initial composition. x+y_{Q} represents a minimum value of the liquid phase mixing ratio (initial composition) of HFO-1123 in the mixed refrigerant in the feeding container.

A difference between the target upper limit composition and the target lower limit composition is called a composition tolerance. The composition tolerance is determined in a case where a composition of a mixed refrigerant is registered in ASHRAE Standard 2013.

In a mixed refrigerant containing HFO-1123 and HFO-1234yf, a case where a mixing ratio of HFO-1123 and HFO-1234yf is, for example, 50:50 (mass %) will be described. In this mixed refrigerant (HFO-1123/HFO-1234yf), in a case where a composition tolerance is set to +1.5, −1.5/+1.5, −1.5, a target upper limit composition of HFO-1123 is 51.5 mass %, and a target lower limit composition of HFO-1123 is 48.5 mass %. Thus, the mixed refrigerant has a difference of 3 mass % between the target upper limit composition and the target lower limit composition.

### (2-2) Filling Method in Case where Filling Amount of Mixed Refrigerant to Container is 100 Mass % of Maximum Filling Amount

A case where a filling amount of a mixed refrigerant to a container is 100 mass % of a maximum filling amount, and a liquid phase mixing ratio of HFO-1123 in the mixed refrigerant in a feeding container allows HFO-1123 to be kept within a range from the target upper limit composition (x)−3.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 22.9 mass % or 57.3 to 91.5 mass %, in a liquid phase, with respect to a total 100 mass % of HFO-1123 and HFO-1234yf, in a liquid from a feeding container, which is filled in an amount of 100 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition), a liquid phase mixing ratio (initial composition) of HFO-1123 in the mixed refrigerant in the feeding container immediately before the transferring and filling is preferably set to x+y_{Q1} to x mass %.

The above-mentioned x is a target upper limit composition (where x satisfies 10≤x≤22.9 or 57.3≤x≤91.5).

y_{Q1} is a lower limit value of a gap between the target upper limit composition and the initial composition and is a value represented by Expression (8).

[Math. 12]

1000y_{Q1}=0.0165x³−3.7774x²+218.61x−3229 (8)

In the present invention, from Expression (8), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−2.2 mass % to x mass %, it is possible to keep compositional changes in the target container and equipment with a range from the target upper limit composition (x)−3.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−3.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91.5 mass %, due to small compositional changes, even if an initial composition of HFO-1123 is about −2.2 mass % with respect to the target upper limit composition, it is possible to keep the liquid phase mixing ratio of HFO-1123 within a range from the target upper limit composition (x)−3.0 mass % (target lower limit composition) to the target upper limit composition (x) until completion of the transferring and filling.

### (2-3) Filling Method in Case where Filling Amount of Mixed Refrigerant to Container is 90 Mass % of Maximum Filling Amount

A case where a filling amount of a mixed refrigerant to a container is 90 mass % of a maximum filling amount, and a liquid phase mixing ratio of HFO-1123 in the mixed refrigerant in a feeding container allows HFO-1123 to be kept within a range from the target upper limit composition (x)−3.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 22.2 mass % or 59.4 to 91.5 mass %, in a liquid phase, with respect to a total 100 mass % of HFO-1123 and HFO-1234yf, in a liquid from a feeding container, which is filled in an amount of 90 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition), a liquid phase mixing ratio (initial composition) of HFO-1123 in the mixed refrigerant in the feeding container immediately before the transferring and filling is preferably set to x+y_{Q2} to x mass %.

The above-mentioned x is a target upper limit composition (where x satisfies 10≤x≤22.2 or 59.4≤x≤91.5).

y_{Q2} is a lower limit value of a gap between the target upper limit composition and the initial composition and is a value represented by Expression (9).

[Math. 13]

1.000y_{Q2}=0.016x³−3.7675x²+222.04x−3250.8 (9)

In the present invention, from Expression (9), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−2.2 mass % to x mass %, it is possible to keep compositional changes in the target container and equipment with a range from the target upper limit composition (x)−3.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−3.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91.5 mass %, due to small compositional changes, even if an initial composition of HFO-1123 is about −2.2 mass % with respect to the target upper limit composition, it is possible to keep the liquid phase mixing ratio of HFO-1123 within a range from the target upper limit composition (x)−3.0 mass % (target lower limit composition) to the target upper limit composition (x) until completion of the transferring and filling.

### (2-4) Filling Method in Case where Filling Amount of Mixed Refrigerant to Container is 80 Mass % of Maximum Filling Amount

A case where a filling amount of a mixed refrigerant to a container is 80 mass % of a maximum filling amount, and a liquid phase mixing ratio of HFO-1123 in the mixed refrigerant in a feeding container allows HFO-1123 to be kept within a range from the target upper limit composition (x)−3.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 22.2 mass % or 59.4 to 91.5 mass %, in a liquid phase, with respect to a total 100 mass % of HFO-1123 and HFO-1234yf, in a liquid from a feeding container, which is filled in an amount of 80 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition), a liquid phase mixing ratio (initial composition) of HFO-1123 in the mixed refrigerant in the feeding container immediately before the transferring and filling is preferably set to x+y_{Q3} to x mass %.

The above-mentioned x is a target upper limit composition (where x satisfies 10≤x≤22.2 or 59.4≤x≤91.5).

y_{Q3} is a lower limit value of a gap between the target upper limit composition and the initial composition and is a value represented by Expression (10).

[Math. 14]

1000y_{Q3}=0.0179x³−4.091x²+236.8x−3274.6 (10)

In the present invention, from Expression (10), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−2.2 mass % to x mass %, it is possible to keep compositional changes in the target container and equipment with a range from the target upper limit composition (x)−3.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−3.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91.5 mass %, due to small compositional changes, even if an initial composition of HFO-1123 is about −2.2 mass % with respect to the target upper limit composition, it is possible to keep the liquid phase mixing ratio of HFO-1123 within a range from the target upper limit composition (x)−3.0 mass % (target lower limit composition) to the target upper limit composition (x) until completion of the transferring and filling.

### (2-5) Filling Method in Case where Filling Amount of Mixed Refrigerant to Container is 70 Mass % of Maximum Filling Amount

A case where a filling amount of a mixed refrigerant to a container is 70 mass % of a maximum filling amount, and a liquid phase mixing ratio of HFO-1123 in the mixed refrigerant in a feeding container allows HFO-1123 to be kept within a range from the target upper limit composition (x)−3.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 20.3 mass % or 61.2 to 91.5 mass %, in a liquid phase, with respect to a total 100 mass % of HFO-1123 and HFO-1234yf, in a liquid from a feeding container, which is filled in an amount of 70 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition), a liquid phase mixing ratio (initial composition) of HFO-1123 in the mixed refrigerant in the feeding container immediately before the transferring and filling is preferably set to x+y_{Q4} to x mass %.

The above-mentioned x is a target upper limit composition (where x satisfies 10≤x≤20.3 or 61.2≤x≤91.5).

y_{Q4} is a lower limit value of a gap between the target upper limit composition and the initial composition and is a value represented by Expression (11).

[Math. 15]

1000y_{Q4}=0.095x³−4.4436x²+257.93x−3425.4 (11)

In the present invention, from Expression (11), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−2.1 mass % to x mass %, it is possible to keep compositional changes in the target container and equipment with a range from the target upper limit composition (x)−3.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−3.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91.5 mass %, due to small compositional changes, even if an initial composition of HFO-1123 is about −2.1 mass % with respect to the target upper limit composition, it is possible to keep the liquid phase mixing ratio of HFO-1123 within a range from the target upper limit composition (x)−3.0 mass % (target lower limit composition) to the target upper limit composition (x) until completion of the transferring and filling.

### (2-6) Filling Method in Case where Filling Amount of Mixed Refrigerant to Container is 60 Mass % of Maximum Filling Amount

A case where a filling amount of a mixed refrigerant to a container is 60 mass % of a maximum filling amount, and a liquid phase mixing ratio of HFO-1123 in the mixed refrigerant in a feeding container allows HFO-1123 to be kept within a range from the target upper limit composition (x)−3.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 17.0 mass % or 67.3 to 91.5 mass %, in a liquid phase, with respect to a total 100 mass % of HFO-1123 and HFO-1234yf, in a liquid from a feeding container, which is filled in an amount of 60 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−3.0 mass % (target lower limit composition), a liquid phase mixing ratio (initial composition) of HFO-1123 in the mixed refrigerant in the feeding container immediately before the transferring and filling is preferably set to x+y_{Q5} to x mass %.

The above-mentioned x is a target upper limit composition (where x satisfies 10≤x≤17.0 or 67.3≤x≤91.5).

y_{Q5} is a lower limit value of a gap between the target upper limit composition and the initial composition and is a value represented by Expression (12).

[Math. 16]

1000y_{Q5}=0.0207x³−4.7469x²+276.68x−3438.1 (12)

In the present invention, from Expression (12), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−2.0 mass % to x mass %, it is possible to keep compositional changes in the target container and equipment with a range from the target upper limit composition (x)−3.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−3.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91.5 mass %, due to small compositional changes, even if an initial composition of HFO-1123 is about −2.0 mass % with respect to the target upper limit composition, it is possible to keep the liquid phase mixing ratio of HFO-1123 within a range from the target upper limit composition (x)−3.0 mass % (target lower limit composition) to the target upper limit composition (x) until completion of the transferring and filling.

### (2-7) Filling Method for Non-Azeotropic Mixed Refrigerant Containing HFO-1123 and HFO-1234yf

A filling method that allows a non-azeotropic mixed refrigerant composed of HFO-1123 and HFO-1234yf to be kept within a range from the target upper limit composition (x) of HFO-1123-3.0 mass % (target lower limit composition) to the target upper limit composition (x) will be described.

Expression (7) can be derived from Expressions (8) to (12). Based on values of coefficients of Expressions (8) to (12), L_{Q} to P_{Q} of Expression (7) can be derived from the target upper limit composition (x) with respect to the initial filling amount (a mass %).

In the filling method for a mixed refrigerant of the present invention, in a case of transferring and filling a mixed refrigerant that contains HFO-1123 and HFO-1234yf in which HFO-1123 is present in an amount of 10 to 91.5 mass %, in a liquid phase, with respect to a total 100 mass % of HFO-1123 and HFO-1234yf, in a liquid from a feeding container to a target container and equipment, in order to keep a liquid phase mixing ratio of HFO-1123 in the mixed refrigerant in the feeding container from start of the transferring and filling until completion thereof within a range from the target upper limit composition (x) of HFO-1123-3.0 mass % (target lower limit composition) to a target upper limit composition (x), a liquid phase mixing ratio (initial composition) of HFO-1123 in the mixed refrigerant in the feeding container immediately before the transferring and filling is set to x+y_{Q} (minimum value) to x (maximum value) mass %.

a: Initial filling amount (mass %) in feeding container

x: Target upper limit composition (mass %, 10≤x≤91.5, except for a range where y_{Q}>0).

y_{Q}: Lower limit value of a gap between target upper limit composition and initial composition, which is a value represented by Expression (7).

[Math. 17]

1000y_{Q}=L_{Q}x³+M_{Q}x²+N_{Q}x+P_{Q}

L_{Q}=−0.0001a+0.0276

M_{Q}=0.0262a−6.2574

N_{Q}=−1.5203a+364.04

P_{Q}=5.928a−3797.8 (7)

### (3) Filling Method in Case where Difference Between Target Upper Limit Composition and Target Lower Limit Composition is 2 Mass %

In a case of transferring and filling a mixed refrigerant in a liquid from a feeding container to a target container and equipment, a mixing ratio of the mixed refrigerant in the feeding container before the transferring and filling will be described so as to keep the liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition).

The above-mentioned “target upper limit composition: (x)” means that the composition of HFO-1123 in the entire composition (liquid phase+gas phase) of the HFO-1123/HFO-1234yf mixed refrigerant required in the target container and equipment is a maximum value that allows the composition to be within this range. x (mass %) is a numerical value within the range of 10≤x≤91. The “target lower limit composition: (x)−2 mass %” means that the composition of HFO-1123 in the entire composition (liquid phase+gas phase) of the HFO-1123/HFO-1234yf mixed refrigerant required in the target container and equipment is a minimum value that allows the composition to be within this range.

### (3-1) Filling Method when the Difference Between the Target Upper Limit Composition and the Target Lower Limit Composition is 2 Mass %

In the filling method for a mixed refrigerant of the present invention in a case where a filling amount of the mixed refrigerant to a container is appropriately adjusted, in a case of transferring and filling a mixed refrigerant, that contains HFO-1123 and HFO-1234yf in which HFO-1123 is present in an amount of 10 to 91 mass %, in a liquid phase, with respect to a total 100 mass % of HFO-1123 and HFO-1234yf, in a liquid from a feeding container to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition), a liquid phase mixing ratio (initial composition) of HFO-1123 in the mixed refrigerant in the feeding container immediately before carrying out the transferring and filling is set to x+y_{R} (minimum value) to x mass % (maximum value).

a: Initial filling amount (mass %) in feeding container

x: Target upper limit composition (mass %, 10≤x≤91, except for a range where y_{R}>0).

y_{R}: Lower limit value of a gap between target upper limit composition and initial composition, which is a value represented by Expression (13).

[Math. 18]

1000y_{R}=L_{R}x³+M_{R}x²+N_{R}X+P_{R}

L_{R}=−0.00005a+0.223

M_{R}=0.0159a−5.5003

N_{R}=−1.0799a+324.91

P_{R}=2.771a−2333.7 (13)

According to the filling method for a mixed refrigerant of the present invention, even in a case where a filling amount of the mixed refrigerant in the feeding container is 100 mass % of a maximum filling amount, by setting a liquid phase mixing ratio of HFO-1123 in the feeding container before carrying out transferring and filling to a specific range, it is possible to keep compositional changes in a target container and equipment with a range from the target upper limit composition (x)−2.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling.

Further, the value of a is usually set within a range of 60≤a≤100.

Hereinafter, as an example of the transferring and filling method, a case where a handling temperature during transferring and filling is 40° C. is shown. For example, in the Japan's High Pressure Gas Safety Act, since handling of containers at 40° C. or higher is prohibited, a handling temperature during transferring and filling in Japan is, in particular, 0° C. to 40° C. As a temperature during transferring and filling (during handling) is higher, compositional changes due to the transferring and filling from start of the transferring and filling until completion thereof become larger in a case of carrying out the transferring and filling in a liquid from the feeding container to the target container and equipment. Therefore, conditions of transferring and filling at a handling temperature of 40° C. are applied, and thus such conditions are also applicable to a handling temperature of 0° C. to 40° C.

Further, regarding also a filling amount in the feeding container, as an initial filling amount is smaller, a range of compositional changes due to the transferring and filling from start of the transferring and filling until completion thereof become smaller in a case of carrying out transferring and filling in a liquid from the feeding container to the target container and equipment. Therefore, a mathematical expression satisfying a filling method in which an initial filling amount is a mass % also satisfies a filling method in which the initial filling amount is a mass % or less. For example, a mathematical expression satisfying a filling method in which an initial filling amount is 100 mass % also satisfies a filling method in which the initial filling amount is 100 to 0 mass %. A mathematical expression satisfying a filling method in which an initial filling amount is 90 mass % also satisfies a filling method in which the initial filling amount is 90 to 0 mass %. A mathematical expression satisfying a filling method in which an initial filling amount is 80 mass % also satisfies a filling method in which the initial filling amount is 80 to 0 mass %. A mathematical expression satisfying a filling method in which an initial filling amount is 70 mass % also satisfies a filling method in which the initial filling amount is 70 to 0 mass %. A mathematical expression satisfying a filling method in which an initial filling amount is 60 mass % also satisfies a filling method in which the initial filling amount is 60 to 0 mass %.

Liquid Phase Mixing Ratio of HFO-1123 in Mixed Refrigerant in Feeding Container

In the present invention, in order to be kept within a range from the target upper limit composition (x) of HFO-1123−2.0 mass % (target lower limit composition) to the target upper limit composition (x), a liquid phase mixing ratio (initial composition) of HFO-1123 in the mixed refrigerant in the feeding container immediately before transferring and filling is set to x+y_{R} (minimum value) to x % (target upper limit composition).

x is a target upper limit composition, and y_{R} is a gap between the target upper limit composition (x) and the initial composition. x+y_{R} represents a minimum value of the liquid phase mixing ratio (initial composition) of HFO-1123 in the mixed refrigerant in the feeding container.

A difference between the target upper limit composition and the target lower limit composition is called a composition tolerance. The composition tolerance is determined in a case where a composition of a mixed refrigerant is registered in ASHRAE Standard 2013.

In a mixed refrigerant containing HFO-1123 and HFO-1234yf, a case where a mixing ratio of HFO-1123 and HFO-1234yf is, for example, 50:50 (mass %) will be described. In this mixed refrigerant (HFO-1123/HFO-1234yf), in a case where a composition tolerance is set to +1.0, −1.0/+1.0, −1.0, a target upper limit composition of HFO-1123 is 51.0 mass %, and a target lower limit composition of HFO-1123 is 49.0 mass %. Thus, the mixed refrigerant has a difference of 2 mass % between the target upper limit composition and the target lower limit composition.

### (3-2) Filling Method in Case where Filling Amount of Mixed Refrigerant to Container is 100 Mass % of Maximum Filling Amount

A case where a filling amount of a mixed refrigerant to a container is 100 mass % of a maximum filling amount, and a liquid phase mixing ratio of HFO-1123 in the mixed refrigerant in a feeding container allows HFO-1123 to be kept within a range from the target upper limit composition (x)−2.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 11.4 mass % or 71.6 to 91 mass %, in a liquid phase, with respect to a total 100 mass % of HFO-1123 and HFO-1234yf, in a liquid from a feeding container, which is filled in an amount of 100 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition), a liquid phase mixing ratio (initial composition) of HFO-1123 in the mixed refrigerant in the feeding container immediately before the transferring and filling is preferably set to x+y_{R1} to x mass %.

The above-mentioned x is a target upper limit composition (where x satisfies 10≤x≤11.4 or 71.6≤x≤91).

y_{R1} is a lower limit value of a gap between the target upper limit composition and the initial composition and is a value represented by Expression (14).

[Math. 19]

1000y_{R1}=0179x³−3.9228x²+217.07x−2003.6 (14)

In the present invention, from Expression (14), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−1.3 mass % to x mass %, it is possible to keep compositional changes in the target container and equipment with a range from the target upper limit composition (x)−2.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−2.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91 mass %, due to small compositional changes, even if an initial composition of HFO-1123 is about −1.3 mass % with respect to the target upper limit composition, it is possible to keep the liquid phase mixing ratio of HFO-1123 within a range from the target upper limit composition (x)−2.0 mass % (target lower limit composition) to the target upper limit composition (x) until completion of the transferring and filling.

### (3-3) Filling Method in Case where Filling Amount of Mixed Refrigerant to Container is 90 Mass % of Maximum Filling Amount

A case where a filling amount of a mixed refrigerant to a container is 90 mass % of a maximum filling amount, and a liquid phase mixing ratio of HFO-1123 in the mixed refrigerant in a feeding container allows HFO-1123 to be kept within a range from the target upper limit composition (x)−2.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 11.6 mass % or 73.0 to 91 mass %, in a liquid phase, with respect to a total 100 mass % of HFO-1123 and HFO-1234yf, in a liquid from a feeding container, which is filled in an amount of 90 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition), a liquid phase mixing ratio (initial composition) of HFO-1123 in the mixed refrigerant in the feeding container immediately before the transferring and filling is preferably set to x+y_{R2} to x mass %.

The above-mentioned x is a target upper limit composition (where x satisfies 10≤x≤11.6 or 73.0≤x≤91).

y_{R2} is a lower limit value of a gap between the target upper limit composition and the initial composition and is a value represented by Expression (15).

[Math. 20]

1000y_{R2}=0.018x³−4.0497x²+227.82x−215.7 (15)

In the present invention, from Expression (15), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−1.3 mass % to x mass %, it is possible to keep compositional changes in the target container and equipment with a range from the target upper limit composition (x)−2.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−2.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91 mass %, due to small compositional changes, even if an initial composition of HFO-1123 is about −1.3 mass % with respect to the target upper limit composition, it is possible to keep the liquid phase mixing ratio of HFO-1123 within a range from the target upper limit composition (x)−2.0 mass % (target lower limit composition) to the target upper limit composition (x) until completion of the transferring and filling.

### (3-4) Filling Method in Case where Filling Amount of Mixed Refrigerant to Container is 80 Mass % of Maximum Filling Amount

A case where a filling amount of a mixed refrigerant to a container is 80 mass % of a maximum filling amount, and a liquid phase mixing ratio of HFO-1123 in the mixed refrigerant in a feeding container allows HFO-1123 to be kept within a range from the target upper limit composition (x)−2.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 11.0 mass % or 74.2 to 91 mass %, in a liquid phase, with respect to a total 100 mass % of HFO-1123 and HFO-1234yf, in a liquid from a feeding container, which is filled in an amount of 80 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition), a liquid phase mixing ratio (initial composition) of HFO-1123 in the mixed refrigerant in the feeding container immediately before the transferring and filling is preferably set to x+y_{R3} to x mass %.

The above-mentioned x is a target upper limit composition (where x satisfies 10≤x≤11.0 or 74.2≤x≤91).

y_{R3} is a lower limit value of a gap between the target upper limit composition and the initial composition and is a value represented by Expression (16).

[Math. 21]

1000y_{R3}=0.0195x³−4.3007x²+240.96x−2169.2 (16)

In the present invention, from Expression (16), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−1.2 mass % to x mass %, it is possible to keep compositional changes in the target container and equipment with a range from the target upper limit composition (x)−2.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−2.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 91 mass %, due to small compositional changes, even if an initial composition of HFO-1123 is about −1.2 mass % with respect to the target upper limit composition, it is possible to keep the liquid phase mixing ratio of HFO-1123 within a range from the target upper limit composition (x)−2.0 mass % (target lower limit composition) to the target upper limit composition (x) until completion of the transferring and filling.

### (3-5) Filling Method in Case where Filling Amount of Mixed Refrigerant to Container is 70 Mass % of Maximum Filling Amount

A case where a filling amount of a mixed refrigerant to a container is 70 mass % of a maximum filling amount, and a liquid phase mixing ratio of HFO-1123 in the mixed refrigerant in a feeding container allows HFO-1123 to be kept within a range from the target upper limit composition (x)−2.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 10 to 10.3 mass % to 75.9 to 91 mass %, in a liquid phase, with respect to a total 100 mass % of HFO-1123 and HFO-1234yf, in a liquid from a feeding container, which is filled in an amount of 70 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition), a liquid phase mixing ratio (initial composition) of HFO-1123 in the mixed refrigerant in the feeding container immediately before the transferring and filling is preferably set to x+y_{R4} to x mass %.

The above-mentioned x is a target upper limit composition (where x satisfies 10≤x≤10.3 or 75.9≤x≤91).

y_{R4} is a lower limit value of a gap between the target upper limit composition and the initial composition and is a value represented by Expression (17).

[Math. 22]

1000y_{R4}=0.019x³−4.2905x²+243.57x−2083 (17)

In the present invention, from Expression (17), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−1.2 mass % to x mass %, it is possible to keep compositional changes in the target container and equipment with a range from the target upper limit composition (x)−2.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−2.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −1.2 mass % with respect to the target upper limit composition, it is possible to keep the liquid phase mixing ratio of HFO-1123 within a range from the target upper limit composition (x)−2.0 mass % (target lower limit composition) to the target upper limit composition (x) until completion of the transferring and filling.

### (3-6) Filling Method in Case where Filling Amount of Mixed Refrigerant to Container is 60 Mass % of Maximum Filling Amount

A case where a filling amount of a mixed refrigerant to a container is 60 mass % of a maximum filling amount, and a liquid phase mixing ratio of HFO-1123 in the mixed refrigerant in a feeding container allows HFO-1123 to be kept within a range from the target upper limit composition (x)−2.0 mass % (target lower limit composition) to the target upper limit composition (x) will be described.

In the filling method for a mixed refrigerant of the present invention, in a case of transferring and filling a mixed refrigerant, that contains HFO-1123 and HFO-1234yf in which HFO-1123 is present in an amount of 77.9 to 91 mass %, in a liquid phase, with respect to a total 100 mass % of HFO-1123 and HFO-1234yf, in a liquid from a feeding container, which is filled in an amount of 60 mass % or less of a maximum filling amount, to a target container and equipment, in order to keep a liquid phase mixing ratio of HFO-1123 in the mixed refrigerant in the feeding container from start of the transferring and filling until completion thereof within a range from a target upper limit composition (x) of HFO-1123 to the target upper limit composition (x)−2.0 mass % (target lower limit composition), a liquid phase mixing ratio (initial composition) of HFO-1123 in the mixed refrigerant in the feeding container immediately before the transferring and filling is preferably set to x+y_{R5} to x mass %.

The above-mentioned x is a target upper limit composition (where x satisfies 77.9≤x≤91).

y_{R5} is a lower limit value of a gap between the target upper limit composition and the initial composition and is a value represented by Expression (18).

[Math. 23]

1000y_{R5}=0.0202x³−4.5952x²+263.19x−2168.5 (18)

In the present invention, from Expression (18), in a case of transferring and filling a HFO-1123/HFO-1234yf mixed refrigerant from a feeding container to a target container and equipment, by setting a liquid phase mixing ratio of HFO-1123 in the feeding container before carrying out the transferring and filling to about x−1.1 mass % to x mass %, it is possible to keep compositional changes in the target container and equipment with a range from the target upper limit composition (x)−2.0 mass % (target lower limit composition) to the target upper limit composition (x) until completion of the transferring and filling.

From the viewpoint that a boiling point of HFO-1123 is lower than that of HFO-1234yf, and, during transferring and filling, in a case where a space generated by extraction of a refrigerant is replenished by evaporation from a liquid phase side, a concentration of HFO-1123 in the liquid phase decreases due to more evaporation of HFO-1123, it is preferable to fill HFO-1123 more than a target composition in the feeding container before transferring and filling. In a filling method for a mixed refrigerant which allows compositional changes of the HFO-1123/HFO-1234yf mixed refrigerant in the target container and equipment to be kept within a range from the target upper limit composition (x)−2.0 mass % (target lower limit composition) to the target upper limit composition (x) until completion of transferring and filling, an upper limit value of a liquid phase mixing ratio of HFO-1123 in the HFO-1123/HFO-1234yf mixed refrigerant is a target upper limit composition of HFO-1123.

Further, in a case where HFO-1123 is contained in an amount of 92 mass %, due to small compositional changes, even if an initial composition of HFO-1123 is about −1.1 mass % with respect to the target upper limit composition, it is possible to keep the liquid phase mixing ratio of HFO-1123 within a range from the target upper limit composition (x)−2.0 mass % (target lower limit composition) to the target upper limit composition (x) until completion of the transferring and filling.

### (3-7) Filling Method for Non-Azeotropic Mixed Refrigerant Containing HFO-1123 and HFO-1234yf

A filling method that allows a non-azeotropic mixed refrigerant composed of HFO-1123 and HFO-1234yf to be kept within a range from the target upper limit composition (x) of HFO-1123−2.0 mass % (target lower limit composition) to the target upper limit composition (x) will be described.

Expression (13) can be derived from Expressions (14) to (18). Based on values of coefficients of Expressions (14) to (18), L_{R} to P_{R} of Expression (13) can be derived from the target upper limit composition (x) with respect to the initial filling amount (a mass %).

In the filling method for a mixed refrigerant of the present invention, in a case of transferring and filling a mixed refrigerant that contains HFO-1123 and HFO-1234yf in which HFO-1123 is present in an amount of 10 to 91 mass %, in a liquid phase, with respect to a total 100 mass % of HFO-1123 and HFO-1234yf, in a liquid from a feeding container to a target container and equipment, in order to keep a liquid phase mixing ratio of HFO-1123 in the mixed refrigerant in the feeding container from start of the transferring and filling until completion thereof within a range from the target upper limit composition (x) of HFO-1123−2.0 mass % (target lower limit composition) to a target upper limit composition (x), a liquid phase mixing ratio (initial composition) of HFO-1123 in the mixed refrigerant in the feeding container immediately before the transferring and filling is set to x+y_{R} (minimum value) to x (maximum value) mass %.

a: Initial filling amount (mass %) in feeding container

x: Target upper limit composition (mass %, 10≤x≤91, except for a range where y_{R}>0).

y_{R}: Lower limit value of a gap between target upper limit composition and initial composition, which is a value represented by Expression (13).

[Math. 24]

1000y_{R}=L_{R}x³+M_{R}x²+N_{R}x+P_{R}

L_{R}=−0.00005a+0.0223

M_{R}=0.0159a−5.5003

N_{R}=−1.0799a+324.91

P_{R}=2.771a−2333.7 (13)

### (4) Addition of Third Component

The present invention is, in particular, directed to a mixed composition containing a HFO-1123/HFO-1234yf mixed refrigerant in which HFO-1123 is present in an amount of 10 to 92 mass %. However, for the purpose of improving properties of the HFO-1123/HFO-1234yf mixed refrigerant, such as enhanced compatibility with refrigerating machine oil, suppressed flammability, reduced GWP, and enhanced refrigerating capacity, to the extent that compositional variation behaviors of the HFO-1123/HFO-1234yf mixed refrigerant is not greatly impaired, non-azeotropic compounds may be added and an addition amount thereof is desirably about 1 to 20 mass %. Non-azeotropic compounds are not particularly limited, and examples thereof include HFC such as HFC-32, HFC-125, HFC-152a, and HFC-143a, HFO such as HFO-1243zf and HFO-1225ye, isobutane, butane, propane, and CO₂. One or two or more of these compounds may be mixed.

The supply-side container of the present invention is not particularly limited as long as it is a closed container capable of storing a refrigerant mixture, and examples thereof include a cylinder, a lorry, and a storage tank. In a case where a volume of the supply-side container is small and an extraction amount at one time is large, influences due to compositional variations are easily exhibited.

Further, in this method, as long as an initial filling amount of the supply-side container is 60 to 100 mass % of a maximum filling amount, transferring and filling may be carried out over several times until completion of the transferring and filling, and the transferring and filling can be interrupted in the middle without complete transferring and filling of a liquid phase.

Further, as equipment which a refrigerant mixture is transferred to and fills, it may be any apparatus that utilizes a vapor compression type refrigeration cycle, and the apparatus is not particularly limited. Examples thereof include a refrigeration air-conditioning apparatus, a refrigerator, and a hot water supply apparatus.

A vapor compression type refrigeration apparatus manufactured by the method of the present invention is composed of a refrigerant and a refrigeration-apparatus main body. The refrigeration-apparatus main body is not particularly limited, and a known refrigeration-apparatus main body is used as it is.

Means for transferring and filling may be in accordance with an ordinary method, and there is, for example, one utilizing a pressure difference and one using a pump or the like.

Further, for example, in the Japan's High Pressure Gas Safety Act, since handling of containers at 40° C. or higher is prohibited, a handling temperature during transferring and filling is basically 0° C. to 40° C. In addition, even in the International Laws, it is required to avoid handling at high temperature. As a temperature at during transferring and filling (during handling) is higher, compositional changes due to the transferring and filling become larger. Therefore, conditions of transferring and filling at a handling temperature of 40° C. are applied, and thus such conditions are also applicable to a handling temperature of 0° C. to 40° C.

### EXAMPLES

Hereinafter, the present invention will be described in accordance with examples in which the filling method for a mixed refrigerant according to the embodiment of the present invention is carried out. However, the present invention is not limited to these examples as long as it does not depart from the gist of the present invention.

First, reference examples to be compared with the examples will be described.

### (1) Reference Example 1

A 10 L closed container was filled with trifluoroethylene (HFO-1123) and 2,3,3,3-tetrafluoropropene (HFO-1234yf) in a composition immediately before transferring and filling at a maximum fillable amount such that a liquid phase thereof has a certain composition at 40° C., and the container was kept at 40° C. The maximum fillable amount is determined by law and is calculated as follows.
G=V/C
G: Mass of fluorocarbon (kg)
V: Internal volume of container (L)
C: Constant depending on type of fluorocarbon

In this case, a filling constant C is defined in Japan as a value obtained by dividing 1.05 by a specific gravity of gas in question at 48° C.

In addition, in a case involving exports, according to the International Law, this filling constant C is defined as a value obtained by dividing 1.05 by a specific gravity of gas in question at 65° C. in a case of passing through tropical regions, and is defined as a value obtained by dividing 1.05 by a specific gravity of gas in question at 45° C. for other regions except the tropics.

This time, a value obtained by dividing 1.05 by a specific gravity of gas in question at 45° C. or 65° C. was adopted as the filling constant.

Further, the reason why 40° C. was chosen as a temperature during transferring and filling is because data at 40° C. is assumed as a case with the worst condition, from the viewpoints that in the Japan's High Pressure Gas Safety Act, handling of containers above 40° C. is prohibited; it is required to avoid handling at high temperature even in the International Law or the like; and compositional changes increase as a temperature rises, data at 40° C. is assumed as a case with the worst condition.

Next, transferring and filling was gradually carried out from a liquid side to another empty container by using a pump. A part of the gas was collected from a sampling valve provided in the middle of a liquid side extraction pipe, and componential composition thereof was analyzed by gas chromatography.

Table 1 shows the results of compositional changes of Reference Example 1 during transferring and filling in case of being filled at a filling amount that is calculated by using, as a filling constant, a value obtained by dividing 1.05 by a specific gravity of the gas in question at 45° C.

TABLE 1

| | | Difference between | | | | | | Composition |
|---|---|---|---|---|---|---|---|---|
| | | target upper | | | HFO-1123 | HFO-1123 | Gap from | at liquid |
| | | limit composition | HFO-1123 | HFO-1123 | composition | composition | HFO-1123 | disappearance ≥ |
| | HFO-1123 | and target | target upper | target lower | before | at time of | target upper | target lower |
| Filling | target | lower limit | limit | limit | transferring | liquid | limit | limit |
| amount | composition | composition | composition | composition | and filling | disappearance | composition | composition |
| Mass % | Mass % | Mass % | Mass % | Mass % | Mass % | Mass % | Mass % | ≥: ◯, <: X |
| 100 | 70 | 4 | 72.0 | 68.0 | 72.0 | 70.0 | −2.0 | ◯ |
| 100 | 70 | 4 | 72.0 | 68.0 | 71.0 | 68.9 | −3.1 | ◯ |
| 100 | 70 | 4 | 72.0 | 68.0 | 70.0 | 67.9 | −4.1 | X |
| 100 | 40 | 4 | 42.0 | 38.0 | 42.0 | 38.5 | −3.5 | ◯ |
| 100 | 40 | 4 | 42.0 | 38.0 | 41.0 | 37.5 | −4.5 | X |
| 100 | 40 | 4 | 42.0 | 38.0 | 40.0 | 36.5 | −5.6 | X |
| 100 | 40 | 4 | 42.0 | 38.0 | 39.0 | 35.4 | −6.6 | X |
| 100 | 80 | 3 | 81.5 | 78.5 | 81.5 | 80.2 | −1.3 | ◯ |
| 100 | 80 | 3 | 81.5 | 78.5 | 81.0 | 79.6 | −1.9 | ◯ |
| 100 | 80 | 3 | 81.5 | 78.5 | 80.0 | 78.6 | −2.9 | ◯ |
| 100 | 80 | 3 | 81.5 | 78.5 | 79.0 | 77.4 | −4.1 | X |
| 100 | 70 | 3 | 71.5 | 68.5 | 71.0 | 68.9 | −2.6 | ◯ |
| 100 | 70 | 3 | 71.5 | 68.5 | 69.0 | 66.8 | −4.7 | X |
| 100 | 40 | 3 | 41.5 | 38.5 | 41.5 | 37.9 | −3.6 | X |
| 100 | 40 | 3 | 41.5 | 38.5 | 40.0 | 36.5 | −5.1 | X |
| 100 | 80 | 2 | 81.0 | 79.0 | 81.0 | 79.6 | −1.4 | ◯ |
| 100 | 80 | 2 | 81.0 | 79.0 | 80.0 | 78.6 | −2.4 | X |
| 100 | 50 | 2 | 51.0 | 49.0 | 51.0 | 47.6 | −3.4 | X |
| 100 | 12 | 2 | 13.0 | 11.0 | 13.0 | 10.9 | −2.1 | X |
| 100 | 12 | 2 | 13.0 | 11.0 | 12.0 | 10.0 | −3.0 | X |
| 60 | 70 | 4 | 72.0 | 68.0 | 72.0 | 69.4 | −2.6 | ◯ |
| 60 | 70 | 4 | 72.0 | 68.0 | 71.0 | 68.3 | −3.7 | ◯ |
| 60 | 70 | 4 | 72.0 | 68.0 | 70.0 | 67.2 | −4.8 | X |
| 60 | 40 | 4 | 42.0 | 38.0 | 42.0 | 37.3 | −4.3 | X |
| 60 | 40 | 4 | 42.0 | 38.0 | 41.0 | 36.7 | −5.3 | X |
| 60 | 40 | 4 | 42.0 | 38.0 | 40.0 | 35.7 | −6.3 | X |
| 60 | 40 | 4 | 42.0 | 38.0 | 39.0 | 34.8 | −7.3 | X |
| 60 | 80 | 3 | 81.5 | 78.5 | 81.5 | 79.8 | −1.7 | ◯ |
| 60 | 80 | 3 | 81.5 | 78.5 | 81.0 | 79.2 | −2.3 | ◯ |
| 60 | 80 | 3 | 81.5 | 78.5 | 80.0 | 78.1 | −3.4 | X |
| 60 | 80 | 3 | 81.5 | 78.5 | 79.0 | 77.0 | −4.5 | X |
| 60 | 70 | 3 | 71.5 | 68.5 | 71.0 | 68.3 | −3.2 | X |
| 60 | 70 | 3 | 71.5 | 68.5 | 69.0 | 66.1 | −5.4 | X |
| 60 | 40 | 3 | 41.5 | 38.5 | 41.5 | 37.1 | −4.4 | X |
| 60 | 40 | 3 | 41.5 | 38.5 | 40.0 | 35.7 | −5.8 | X |
| 60 | 80 | 2 | 81.0 | 79.0 | 81.0 | 79.2 | −1.8 | ◯ |
| 60 | 80 | 2 | 81.0 | 79.0 | 80.0 | 78.1 | −2.9 | X |
| 60 | 50 | 2 | 51.0 | 49.0 | 51.0 | 46.9 | −4.1 | X |
| 60 | 12 | 2 | 13.0 | 11.0 | 13.0 | 10.5 | −2.5 | X |
| 60 | 12 | 2 | 13.0 | 11.0 | 12.0 | 9.7 | −3.3 | X |

From Table 1, it was found that a concentration of HFO-1123 in the HFO-1123/HFO-1234yf mixed refrigerant at the time of completion of transferring and filling (at the time of liquid disappearance) is lower than that at start of the transferring and filling. This is because a boiling point of HFO-1123 is lower than that of HFO-1234yf, and, during the transferring and filling, in a case where a space generated by extraction of a refrigerant is replenished by evaporation from a liquid phase side, a concentration of HFO-1123 in the liquid phase decreases due to more evaporation of HFO-1123. Therefore, it was found that it is preferable to fill more than a target composition in the feeding container before transferring and filling of HFO-1123.

From Table 1, in a case where there is a certain target composition and a compositional range of upper and lower limits including the target composition is set to 2 to 4, in a case of initiating transferring and filling by using a certain composition within the compositional range as an initial composition without taking any measures, there is a possibility that a composition at the time of completion of the transferring and filling (at the time of liquid disappearance) becomes equal to or less than a target lower limit composition. As a result, refrigerating capacity and refrigerant capability, such as COP, which are anticipated with the target composition, cannot be guaranteed from start of the transferring and filling to completion of the transferring and filling.

Therefore, in a case of setting a target composition, and a target upper limit composition and a target lower limit composition including the target composition, the present inventors have clarified how to set an initial composition in the compositional range, so that all the compositions from start of the transferring and filling to completion of the transferring and filling can be kept within the target lower limit composition to the target upper limit composition.

### (2) Filling Method in Case where Difference Between Target Upper Limit Composition and Target Lower Limit Composition is 4 Mass %

### (2-1) Example 1: Initial Filling Amount in Feeding Container is 100 Mass % of Maximum Filling Amount

A 10 L closed container was filled with HFO-1234yf and HFO-1123 in a composition before transferring and filling at a maximum fillable amount (filling amount of 100 mass %) such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Reference Example 1, transferring and filling was gradually carried out from a liquid side to another empty container by using a pump, and a componential composition was analyzed. Table 2 shows the results of compositional changes during the transferring and filling in a case of being adjusted to the target upper limit composition.

TABLE 2

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 92.0 | 91.5 | −1.5 |
| 80.0 | 82.0 | 80.8 | −0.8 |
| 70.0 | 72.0 | 70.0 | 0.0 |
| 60.0 | 62.0 | 59.3 | 0.7 |
| 50.0 | 52.0 | 48.7 | 1.3 |
| 40.0 | 42.0 | 38.5 | 1.5 |
| 30.0 | 32.0 | 28.6 | 1.5 |
| 20.0 | 22.0 | 18.9 | 1.1 |
| 10.0 | 12.0 | 10.0 | 0.0 |

As shown in Table 2, in a case where, by setting the initial composition before the transferring and filling to the target upper limit composition, a HFO-1123 composition is allowed to be in a range of 10 to 92 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−4.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{P1}) of a gap between the target upper limit composition and the initial composition at this time is shown in Table 3.

TABLE 3

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 92.0 | 88.8 | 88.0 | −3.2 |
| 82.0 | 79.5 | 78.0 | −2.5 |
| 72.0 | 70.2 | 68.0 | −1.8 |
| 62.0 | 60.8 | 58.0 | −1.2 |
| 52.0 | 51.3 | 48.0 | −0.7 |
| 42.0 | 41.6 | 38.0 | −0.5 |
| 32.0 | 31.6 | 28.0 | −0.4 |
| 22.0 | 21.0 | 18.0 | −1.1 |
| 12.0 | 9.7 | 8.0 | −2.3 |

From these results, compositional variations of HFO-1123 is the smallest in the target composition of 92 mass %, and, even in a case where an initial composition of HFO-1123 in the liquid phase mixed refrigerant of HFO-1123/HFO-1234yf is set to −3.2 mass % of the target composition, HFO-1123 can be kept within a range from the target upper limit composition−4.0 mass % (target lower limit composition) to the target upper limit composition from before the transferring and filling until completion of the transferring and filling.

Further, from these results, the lower limit value (y_{P1}) of the gap between the target upper limit composition and the initial composition can be represented by the following expression using the target composition (x).

[Math. 25]

1000y_{P1}=0.0033x³−0.8601x²+55.026x−4187.6 (2)

From Table 1, a question as to where the target composition should be set between the target lower limit and the target upper limit was raised. By setting the lower limit value (y_{P1}) based on Table 3, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{P1} to the target upper limit composition, HFO-1123 can be kept within a range from the target upper limit composition−4.0 mass % (target lower limit composition) to the target upper limit composition from before the transferring and filling until completion of the transferring and filling.

### (2-2) Example 2: Initial Filling Amount in Feeding Container is 90 Mass % of Maximum Filling Amount

A 10 L closed container was filled with HFO-1234yf and HFO-1123 in a composition before transferring and filling at 90 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 1, transferring and filling was gradually carried out from a liquid side to another empty container by using a pump, and a componential composition was analyzed. Table 4 shows the results of compositional changes during the transferring and filling in a case of being adjusted to the target upper limit composition.

TABLE 4

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 92.0 | 91.5 | −1.5 |
| 80.0 | 82.0 | 80.7 | −0.7 |
| 70.0 | 72.0 | 69.9 | 0.1 |
| 60.0 | 62.0 | 59.2 | 0.8 |
| 50.0 | 52.0 | 48.7 | 1.3 |
| 40.0 | 42.0 | 38.4 | 1.7 |
| 30.0 | 32.0 | 28.5 | 1.5 |
| 20.0 | 22.0 | 19.0 | 1.1 |
| 10.0 | 12.0 | 10.0 | 0.0 |

As shown in Table 4, in a case where, by setting the initial composition before the transferring and filling to the target upper limit composition, a HFO-1123 composition is allowed to be in a range of 10 to 92 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−4.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{P2}) of a gap between the target upper limit composition and the initial composition at this time is shown in Table 5.

TABLE 5

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 92.0 | 88.9 | 88.0 | −3.2 |
| 82.0 | 79.6 | 78.0 | −2.5 |
| 72.0 | 70.3 | 68.0 | −1.8 |
| 62.0 | 60.9 | 58.0 | −1.2 |
| 52.0 | 51.4 | 48.0 | −0.6 |
| 42.0 | 41.6 | 38.1 | −0.4 |
| 32.0 | 31.6 | 28.0 | −0.4 |
| 22.0 | 21.0 | 18.0 | −1.0 |
| 12.0 | 9.8 | 8.0 | −2.3 |

From these results, compositional variations of HFO-1123 is the smallest in the target upper limit composition of 92 mass %, and, even in a case where an initial composition of HFO-1123 in the liquid phase mixed refrigerant of HFO-1123/HFO-1234yf is set to −3.2 mass % of the target upper limit composition, HFO-1123 can be kept within a range from the target upper limit composition−4.0 mass % (target lower limit composition) to the target upper limit composition from before the transferring and filling until completion of the transferring and filling.

Further, from these results, the lower limit value (y_{P2}) of the gap between the target upper limit composition and the initial composition can be represented by the following expression using the target upper limit composition (x).

[Math. 26]

1000y_{P2}=0.0037x³−0.9392x²+59.651x−4243 (3)

By setting the lower limit value (y_{P2}) based on Table 5, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{P2} to the target upper limit composition, HFO-1123 can be kept within a range from the target upper limit composition−4.0 mass % (target lower limit composition) to the target upper limit composition from before the transferring and filling until completion of the transferring and filling.

### (2-3) Example 3: Initial Filling Amount in Feeding Container is 80 Mass % of Maximum Filling Amount

A 10 L closed container was filled with HFO-1234yf and HFO-1123 in a composition before transferring and filling at 80 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 1, transferring and filling was gradually carried out from a liquid side to another empty container by using a pump, and a componential composition was analyzed. Table 6 shows the results of compositional changes during the transferring and filling in a case of being adjusted to the target upper limit composition.

TABLE 6

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 92.0 | 91.4 | −1.4 |
| 80.0 | 82.0 | 80.7 | −0.7 |
| 70.0 | 72.0 | 69.9 | −0.2 |
| 60.0 | 62.0 | 59.1 | 1.0 |
| 50.0 | 52.0 | 48.5 | 1.5 |
| 40.0 | 42.0 | 38.2 | 1.8 |
| 30.0 | 32.0 | 218.4 | 1.7 |
| 20.0 | 22.0 | 18.8 | 1.2 |
| 10.0 | 12.0 | 9.9 | 0.1 |

As shown in Table 6, in a case where, by setting the initial composition before the transferring and filling to the target upper limit composition, a HFO-1123 composition is allowed to be in a range of 10 to 92 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−4.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{P3}) of a gap between the target upper limit composition and the initial composition at this time is shown in Table 7.

TABLE 7

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 92.0 | 88.9 | 88.0 | −3.2 |
| 82.0 | 79.7 | 78.0 | −2.3 |
| 72.0 | 70.4 | 68.0 | −1.7 |
| 62.0 | 61.0 | 57.0 | −1.0 |
| 52.0 | 51.5 | 48.0 | −0.5 |
| 42.0 | 41.8 | 38.0 | −0.2 |
| 32.0 | 31.7 | 28.0 | −0.3 |
| 22.0 | 21.2 | 18.0 | −0.9 |
| 12.0 | 9.8 | 8.0 | −2.2 |

From these results, compositional variations of HFO-1123 is the smallest in the target upper limit composition of 92 mass %, and, even in a case where an initial composition of HFO-1123 in the liquid phase mixed refrigerant of HFO-1123/HFO-1234yf is set to −3.2 mass % of the target upper limit composition, HFO-1123 can be kept within a range from the target upper limit composition−4.0 mass % (target lower limit composition) to the target upper limit composition from before the transferring and filling until completion of the transferring and filling.

Further, from these results, the lower limit value (y_{P3}) of the gap between the target upper limit composition and the initial composition can be represented by Expression (4) using the target upper limit composition (x).

[Math. 27]

1000y_{P3}=0.0038x³−0.979x²+62.141x−4268.4 (4)

By setting the lower limit value (y_{P3}) based on Table 7, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{P3} to the target upper limit composition, HFO-1123 can be kept within a range from the target upper limit composition−4.0 mass % (target lower limit composition) to the target upper limit composition from before the transferring and filling until completion of the transferring and filling.

### (2-4) Example 4: Initial Filling Amount in Feeding Container is 70 Mass % of Maximum Filling Amount

A 10 L closed container was filled with HFO-1234yf and HFO-1123 in a composition before transferring and filling at 70 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 1, transferring and filling was gradually carried out from a liquid side to another empty container by using a pump, and a componential composition was analyzed. Table 8 shows the results of compositional changes during the transferring and filling in a case of being adjusted to the target upper limit composition.

TABLE 8

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 92.0 | 91.4 | −1.4 |
| 80.0 | 82.0 | 80.6 | −0.6 |
| 70.0 | 72.0 | 69.6 | 0.4 |
| 60.0 | 62.0 | 58.9 | 1.1 |
| 50.0 | 52.0 | 48.3 | 1.7 |
| 40.0 | 42.0 | 38.0 | 2.0 |
| 30.0 | 32.0 | 28.1 | 1.9 |
| 20.0 | 22.0 | 18.6 | 1.4 |
| 10.0 | 12.0 | 9.8 | 0.2 |

As shown in Table 8, in a case where, by setting the initial composition before the transferring and filling to the target upper limit composition, a HFO-1123 composition is allowed to be in a range of 10 to 92 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−4.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{P4}) of a gap between the target upper limit composition and the initial composition at this time is shown in Table 9.

TABLE 9

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 92.0 | 89.0 | 88.0 | −3.1 |
| 82.0 | 79.7 | 78.0 | −2.3 |
| 72.0 | 70.5 | 68.0 | −1.5 |
| 62.0 | 61.2 | 58.0 | −0.8 |
| 52.0 | 51.7 | 48.0 | −0.3 |
| 42.0 | 42.0 | 38.0 | 0.0 |
| 32.0 | 31.9 | 28.0 | −0.1 |
| 22.0 | 21.2 | 18.0 | −0.8 |
| 12.0 | 9.9 | 8.0 | −2.2 |

From these results, compositional variations of HFO-1123 is the smallest in the target upper limit composition of 92 mass %, and, even in a case where an initial composition of HFO-1123 in the liquid phase mixed refrigerant of HFO-1123/HFO-1234yf is set to −3.1 mass % of the target upper limit composition, HFO-1123 can be kept within a range from the target upper limit composition−4.0 mass % (target lower limit composition) to the target upper limit composition from before the transferring and filling until completion of the transferring and filling.

Further, from these results, the lower limit value (y_{P4}) of the gap between the target upper limit composition and the initial composition can be represented by Expression (5) using the target upper limit composition (x).

[Math. 28]

1000y_{P4}=0.41x³−1.059x²+67,479x−4314.9 (5)

By setting the lower limit value (y_{P4}) based on Table 9, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{P4} to the target upper limit composition, HFO-1123 can be kept within a range from the target upper limit composition−4.0 mass % (target lower limit composition) to the target upper limit composition from before the transferring and filling until completion of the transferring and filling.

### (2-5) Example 5: Initial Filling Amount in Feeding Container is 60 Mass % of Maximum Filling Amount

A 10 L closed container was filled with HFO-1234yf and HFO-1123 in a composition before transferring and filling at 60 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 1, transferring and filling was gradually carried out from a liquid side to another empty container by using a pump, and a componential composition was analyzed. Table 10 shows the results of compositional changes during the transferring and filling in a case of being adjusted to the target upper limit composition.

TABLE 10

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 92.0 | 91.3 | −1.3 |
| 80.0 | 82.0 | 80.4 | −0.4 |
| 70.0 | 72.0 | 69.4 | 0.6 |
| 60.0 | 62.0 | 58.6 | 1.4 |
| 50.0 | 52.0 | 47.9 | 2.1 |
| 40.0 | 42.0 | 37.7 | 2.3 |
| 30.0 | 32.0 | 27.8 | 2.2 |
| 20.0 | 22.0 | 18.4 | 1.6 |
| 10.0 | 12.0 | 9.7 | 0.3 |

As shown in Table 10, in a case where, by setting the initial composition before the transferring and filling to the target upper limit composition, a HFO-1123 composition is allowed to be in a range of 10 to 28.7 mass % or 54.0 to 92 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−4.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{P5}) of a gap between the target upper limit composition and the initial composition at this time is shown in Table 11.

TABLE 11

| | HFO-1123 | | Lower limit value |
|---|---|---|---|
| HFO-1123 | composition | HFO-1123 | (ya) of gap from |
| target | before | composition | HFO-1123 |
| upper limit | transferring | at time of liquid | target upper limit |
| composition | and filling | disappearance | composition |
| Mass % | Mass % | Mass % | Mass % |
| 92.0 | 89.0 | 88.0 | −3.0 |
| 82.0 | 79.9 | 78.0 | −2.1 |
| 72.0 | 70.8 | 68.0 | −1.3 |
| 62.0 | 61.5 | 58.0 | −0.5 |
| 54.0 | 54.0 | 48.0 | 0.0 |
| 28.7 | 28.7 | 28.0 | 0.0 |
| 22.0 | 21.5 | 18.0 | −0.5 |
| 12.0 | 10.0 | 8.0 | −2.0 |

From these results, compositional variations of HFO-1123 is the smallest in the target upper limit composition of 92 mass %, and, even in a case where an initial composition of HFO-1123 in the liquid phase mixed refrigerant of HFO-1123/HFO-1234yf is set to −3.0 mass % of the target upper limit composition, HFO-1123 can be kept within a range from the target upper limit composition−4.0 mass % (target lower limit composition) to the target upper limit composition from before the transferring and filling until completion of the transferring and filling.

Further, from these results, the lower limit value (y_{P5}) of the gap between the target upper limit composition and the initial composition can be represented by the following expression using the target upper limit composition (x).

[Math. 29]

1000y_{P5}=00039x³−1.0614x²+9.262x−4292.6 (6)

By setting the lower limit value (y_{P5}) based on Table 11, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{P5} to the target upper limit composition, HFO-1123 can be kept within a range from the target upper limit composition−4.0 mass % (target lower limit composition) to the target upper limit composition from before the transferring and filling until completion of the transferring and filling.

### (3) Filling Method in Case where Difference Between Target Upper Limit Composition and Target Lower Limit Composition is 3 Mass %

### (3-1) Example 6: Initial Filling Amount in Feeding Container is 100 Mass % of Maximum Filling Amount

A 10 L closed container was filled with HFO-1234yf and HFO-1123 in a composition before transferring and filling at a maximum fillable amount (filling amount of 100 mass %) such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Reference Example 1, transferring and filling was gradually carried out from a liquid side to another empty container by using a pump, and a componential composition was analyzed. Table 12 shows the results of compositional changes during the transferring and filling in a case of being adjusted to the target upper limit composition.

TABLE 12

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.5 | 90.9 | −0.9 |
| 80.0 | 81.5 | 80.2 | −0.2 |
| 70.0 | 71.5 | 69.4 | 0.6 |
| 60.0 | 61.5 | 58.7 | 1.3 |
| 50.0 | 51.5 | 48.3 | 1.7 |
| 40.0 | 41.5 | 37.9 | 2.1 |
| 30.0 | 31.5 | 27.9 | 2.1 |
| 20.0 | 21.5 | 18.5 | 1.5 |
| 10.0 | 11.5 | 9.6 | 0.4 |

As shown in Table 12, in a case where, by setting the initial composition before the transferring and filling to the target upper limit composition, a HFO-1123 composition is allowed to be in a range of 10 to 91.5 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−3.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{Q1}) of a gap between the target upper limit composition and the initial composition at this time is shown in Table 13.

TABLE 13

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.5 | 89.3 | 88.5 | −2.2 |
| 81.5 | 80.0 | 78.5 | −1.6 |
| 71.5 | 70.7 | 68.5 | −0.8 |
| 61.5 | 61.3 | 58.5 | −0.2 |
| 57.3 | 57.3 | 54.3 | 0.0 |
| 22.9 | 22.9 | 19.9 | 0.0 |
| 11.5 | 10.3 | 8.5 | −1.3 |

From these results, compositional variations of HFO-1123 is the smallest in the target upper limit composition of 91.5 mass %, and, even in a case where an initial composition of HFO-1123 in the liquid phase mixed refrigerant of HFO-1123/HFO-1234yf is set to −2.2 mass % of the target upper limit composition, HFO-1123 can be kept within a range from the target upper limit composition−3.0 mass % (target lower limit composition) to the target upper limit composition from before the transferring and filling until completion of the transferring and filling.

Further, from these results, the lower limit value (y_{Q1}) of the gap between the target upper limit composition and the initial composition can be represented by the following expression using the target upper limit composition (x).

[Math. 30]

1000y_{Q1}=0.0041x^{a}−0.9955x²+60.515x−3228.6 (8)

By setting the lower limit value (y_{Q1}) based on Table 13, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{Q1} to the target upper limit composition, HFO-1123 can be kept within a range from the target upper limit composition−3.0 mass % (target lower limit composition) to the target upper limit composition from before the transferring and filling until completion of the transferring and filling.

### (3-2) Example 7: Initial Filling Amount in Feeding Container is 90 Mass % of Maximum Filling Amount

A 10 L closed container was filled with HFO-1234yf and HFO-1123 in a composition before transferring and filling at 90 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 6, transferring and filling was gradually carried out from a liquid side to another empty container by using a pump, and a componential composition was analyzed. Table 14 shows the results of compositional changes during the transferring and filling in a case of being adjusted to the target upper limit composition.

TABLE 14

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.5 | 90.9 | −0.9 |
| 80.0 | 81.5 | 80.1 | −0.1 |
| 70.0 | 71.5 | 69.4 | 0.6 |
| 60.0 | 61.5 | 58.7 | 1.4 |
| 50.0 | 51.5 | 48.1 | 1.9 |
| 40.0 | 41.5 | 37.9 | 2.1 |
| 30.0 | 31.5 | 27.9 | 2.1 |
| 20.0 | 21.5 | 18.5 | 1.5 |
| 10.0 | 11.5 | 9.5 | 0.5 |

As shown in Table 14, in a case where, by setting the initial composition before the transferring and filling to the target upper limit composition, a HFO-1123 composition is allowed to be in a range of 10 to 22.2 mass % or 59.4 to 91.5 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−3.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{Q2}) of a gap between the target upper limit composition and the initial composition at this time is shown in Table 15.

TABLE 15

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.5 | 89.3 | 88.5 | −2.2 |
| 81.5 | 80.0 | 78.5 | −1.5 |
| 71.5 | 70.8 | 68.5 | −0.8 |
| 61.5 | 61.4 | 58.5 | −0.1 |
| 59.4 | 59.4 | 56.4 | 0.0 |
| 22.2 | 22.2 | 19.2 | 0.0 |
| 11.5 | 10.3 | 8.5 | −1.2 |

From these results, compositional variations of HFO-1123 is the smallest in the target upper limit composition of 91.5 mass %, and, even in a case where an initial composition of HFO-1123 in the liquid phase mixed refrigerant of HFO-1123/HFO-1234yf is set to −2.2 mass % of the target upper limit composition, HFO-1123 can be kept within a range from the target upper limit composition−3.0 mass % (target lower limit composition) to the target upper limit composition from before the transferring and filling until completion of the transferring and filling.

Further, from these results, the lower limit value (y_{Q2}) of the gap between the target upper limit composition and the initial composition can be represented by the following expression using the target upper limit composition (x).

[Math. 31]

1000y_{Q2}=0.0038x³−0.9548x²+59.27x−3212.2 (9)

By setting the lower limit value (y_{Q2}) based on Table 15, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{Q2} to the target upper limit composition, HFO-1123 can be kept within a range from the target upper limit composition−3.0 mass % (target lower limit composition) to the target upper limit composition from before the transferring and filling until completion of the transferring and filling.

### (3-3) Example 8: Initial Filling Amount in Feeding Container is 80 Mass % of Maximum Filling Amount

A 10 L closed container was filled with HFO-1234yf and HFO-1123 in a composition before transferring and filling at 80 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 6, transferring and filling was gradually carried out from a liquid side to another empty container by using a pump, and a componential composition was analyzed. Table 16 shows the results of compositional changes during the transferring and filling in a case of being adjusted to the target upper limit composition.

TABLE 16

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.5 | 90.8 | −0.8 |
| 80.0 | 81.5 | 80.0 | 0.0 |
| 70.0 | 71.5 | 69.2 | 0.8 |
| 60.0 | 61.5 | 58.5 | 1.5 |
| 50.0 | 51.5 | 48.0 | 2.0 |
| 40.0 | 41.5 | 37.7 | 2.3 |
| 30.0 | 31.5 | 27.8 | 2.2 |
| 20.0 | 21.5 | 18.3 | 1.7 |
| 10.0 | 11.5 | 9.5 | 0.6 |

As shown in Table 16, in a case where, by setting the initial composition before the transferring and filling to the target upper limit composition, a HFO-1123 composition is allowed to be in a range of 10 to 22.2 mass % or 59.4 to 91.5 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−3.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{Q3}) of a gap between the target upper limit composition and the initial composition at this time is shown in Table 17.

TABLE 17

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.5 | 89.4 | 88.5 | −2.2 |
| 81.5 | 80.1 | 78.5 | −1.4 |
| 71.5 | 70.8 | 68.5 | −0.7 |
| 59.4 | 59.4 | 56.4 | 0.0 |
| 22.2 | 22.2 | 19.2 | 0.0 |
| 11.5 | 10.4 | 8.5 | −1.1 |

From these results, compositional variations of HFO-1123 is the smallest in the target upper limit composition of 91.5 mass %, and, even in a case where an initial composition of HFO-1123 in the liquid phase mixed refrigerant of HFO-1123/HFO-1234yf is set to −2.2 mass % of the target upper limit composition, HFO-1123 can be kept within a range from the target upper limit composition−3.0 mass % (target lower limit composition) to the target upper limit composition from before the transferring and filling until completion of the transferring and filling.

Further, from these results, the lower limit value (y_{Q3}) of the gap between the target upper limit composition and the initial composition can be represented by Expression (10) using the target upper limit composition (x).

[Math. 32]

1000y_{Q3}=0.0035x³−0.9196x²+57,749x−3152.4 (10)

By setting the lower limit value (y_{Q3}) based on Table 17, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{Q3} to the target upper limit composition, HFO-1123 can be kept within a range from the target upper limit composition−3.0 mass % (target lower limit composition) to the target upper limit composition from before the transferring and filling until completion of the transferring and filling.

### (3-4) Example 9: Initial Filling Amount in Feeding Container is 70 Mass % of Maximum Filling Amount

A 10 L closed container was filled with HFO-1234yf and HFO-1123 in a composition before transferring and filling at 70 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 6, transferring and filling was gradually carried out from a liquid side to another empty container by using a pump, and a componential composition was analyzed. Table 18 shows the results of compositional changes during the transferring and filling in a case of being adjusted to the target upper limit composition.

TABLE 18

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.5 | 90.8 | −0.8 |
| 80.0 | 81.5 | 79.9 | 0.1 |
| 70.0 | 71.5 | 69.1 | 0.9 |
| 60.0 | 61.5 | 58.3 | 1.7 |
| 50.0 | 51.5 | 47.8 | 2.2 |
| 40.0 | 41.5 | 37.5 | 2.5 |
| 30.0 | 31.5 | 27.6 | 2.4 |
| 20.0 | 21.5 | 18.3 | 1.8 |
| 10.0 | 11.5 | 9.4 | 0.6 |

As shown in Table 18, in a case where, by setting the initial composition before the transferring and filling to the target upper limit composition, a HFO-1123 composition is allowed to be in a range of 10 to 20.3 mass % or 61.2 to 91.5 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−3.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{Q4}) of a gap between the target upper limit composition and the initial composition at this time is shown in Table 19.

TABLE 19

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.5 | 89.4 | 88.5 | −2.1 |
| 81.5 | 80.2 | 78.5 | −1.3 |
| 71.5 | 71.0 | 68.5 | −0.5 |
| 61.2 | 61.2 | 58.2 | 0.0 |
| 20.3 | 20.3 | 17.3 | 0.0 |
| 11.5 | 10.5 | 8.5 | −1.1 |

From these results, compositional variations of HFO-1123 is the smallest in the target upper limit composition of 91.5 mass %, and, even in a case where an initial composition of HFO-1123 in the liquid phase mixed refrigerant of HFO-1123/HFO-1234yf is set to −2.1 mass % of the target upper limit composition, HFO-1123 can be kept within a range from the target upper limit composition−3.0 mass % (target lower limit composition) to the target upper limit composition from before the transferring and filling until completion of the transferring and filling.

Further, from these results, the lower limit value (y_{Q4}) of the gap between the target upper limit composition and the initial composition can be represented by Expression (11) using the target upper limit composition (x).

[Math. 33]

1000y_{Q4}=0.003x³−0.8664x²+57.441x−3154.1 (11)

By setting the lower limit value (y_{Q4}) based on Table 19, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{Q4} to the target upper limit composition, HFO-1123 can be kept within a range from the target upper limit composition−3.0 mass % (target lower limit composition) to the target upper limit composition from before the transferring and filling until completion of the transferring and filling.

### (3-5) Example 10: Initial Filling Amount in Feeding Container is 60 Mass % of Maximum Filling Amount

A 10 L closed container was filled with HFO-1234yf and HFO-1123 in a composition before transferring and filling at 60 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 6, transferring and filling was gradually carried out from a liquid side to another empty container by using a pump, and a componential composition was analyzed. Table 20 shows the results of compositional changes during the transferring and filling in a case of being adjusted to the target upper limit composition.

TABLE 20

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.5 | 90.7 | −0.7 |
| 80.0 | 81.5 | 79.8 | 0.2 |
| 70.0 | 71.5 | 68.8 | 1.2 |
| 60.0 | 61.5 | 58.0 | 2.0 |
| 50.0 | 51.5 | 47.5 | 2.5 |
| 40.0 | 41.5 | 37.1 | 2.9 |
| 30.0 | 31.5 | 27.3 | 2.7 |
| 20.0 | 21.5 | 18.0 | 2.0 |
| 10.0 | 11.5 | 9.2 | 0.8 |

As shown in Table 20, in a case where, by setting the initial composition before the transferring and filling to the target upper limit composition, a HFO-1123 composition is allowed to be in a range of 10 to 17.0 mass % or 67.3 to 91.5 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−3.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{Q5}) of a gap between the target upper limit composition and the initial composition at this time is shown in Table 21.

TABLE 21

| | HFO-1123 | | Lower limit value |
|---|---|---|---|
| HFO-1123 | composition | HFO-1123 | (yb) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.5 | 89.5 | 88.5 | −2.0 |
| 81.5 | 80.4 | 78.5 | −1.2 |
| 71.5 | 71.2 | 68.5 | −0.3 |
| 67.3 | 67.3 | 64.3 | 0.0 |
| 17.0 | 17.0 | 14.0 | 0.0 |
| 11.5 | 10.6 | 8.5 | −0.9 |

From these results, compositional variations of HFO-1123 is the smallest in the target upper limit composition of 91.5 mass %, and, even in a case where an initial composition of HFO-1123 in the liquid phase mixed refrigerant of HFO-1123/HFO-1234yf is set to −2.0 mass % of the target upper limit composition, HFO-1123 can be kept within a range from the target upper limit composition−3.0 mass % (target lower limit composition) to the target upper limit composition from before the transferring and filling until completion of the transferring and filling.

Further, from these results, the lower limit value (y_{Q5}) of the gap between the target upper limit composition and the initial composition can be represented by Expression (12) using the target upper limit composition (x).

[Math. 34]

1000Y_{Q5}=0.0028x³−0.8507x²+57.326x−3105.5 (12)

By setting the lower limit value (y_{Q5}) based on Table 21, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{Q5} to the target upper limit composition, HFO-1123 can be kept within a range from the target upper limit composition−3.0 mass % (target lower limit composition) to the target upper limit composition from before the transferring and filling until completion of the transferring and filling.

### (4) Filling Method in Case where Difference Between Target Upper Limit Composition and Target Lower Limit Composition is 2 Mass %

### (4-1) Example 11: Initial Filling Amount in Feeding Container is 100 Mass % of Maximum Filling Amount

A 10 L closed container was filled with HFO-1234yf and HFO-1123 in a composition before transferring and filling at a maximum fillable amount (filling amount of 100 mass %) such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Reference Example 1, transferring and filling was gradually carried out from a liquid side to another empty container by using a pump, and a componential composition was analyzed. Table 22 shows the results of compositional changes during the transferring and filling in a case of being adjusted to the target upper limit composition.

TABLE 22

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.0 | 90.3 | −0.3 |
| 80.0 | 81.0 | 79.6 | 0.4 |
| 70.0 | 71.0 | 68.8 | 1.2 |
| 60.0 | 61.0 | 58.2 | 1.8 |
| 50.0 | 51.0 | 47.6 | 2.4 |
| 40.0 | 41.0 | 37.4 | 2.6 |
| 30.0 | 31.0 | 27.4 | 2.6 |
| 20.0 | 21.0 | 18.0 | 2.0 |
| 10.0 | 11.0 | 9.1 | 0.9 |

As shown in Table 22, in a case where, by setting the initial composition before the transferring and filling to the target upper limit composition, a HFO-1123 composition is allowed to be in a range of 10 to 11.4 mass % or 71.6 to 91 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−2.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{R1}) of a gap between the target upper limit composition and the initial composition at this time is shown in Table 23.

TABLE 23

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.0 | 89.8 | 89.0 | −1.3 |
| 81.0 | 80.4 | 79.0 | −0.6 |
| 71.6 | 71.6 | 69.6 | 0.0 |
| 11.4 | 11.4 | 9.4 | 0.0 |
| 11.0 | 10.9 | 9.0 | −0.1 |

From these results, compositional variations of HFO-1123 is the smallest in the target upper limit composition of 91 mass %, and, even in a case where an initial composition of HFO-1123 in the liquid phase mixed refrigerant of HFO-1123/HFO-1234yf is set to −1.3 mass % of the target upper limit composition, HFO-1123 can be kept within a range from the target upper limit composition−2.0 mass % (target lower limit composition) to the target upper limit composition from before the transferring and filling until completion of the transferring and filling.

Further, from these results, the lower limit value (y_{R1}) of the gap between the target upper limit composition and the initial composition can be represented by Expression (14) using the target upper limit composition (x).

[Math. 35]

1000y_{R1}=0.0029x³−0.7982x²+49.947x−2063.8 (14)

By setting the lower limit value (y_{R1}) based on Table 23, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{R1} to the target upper limit composition, HFO-1123 can be kept within a range from the target upper limit composition−2.0 mass % (target lower limit composition) to the target upper limit composition from before the transferring and filling until completion of the transferring and filling.

### (4-2) Example 12: Initial Filling Amount in Feeding Container is 90 Mass % of Maximum Filling Amount

A 10 L closed container was filled with HFO-1234yf and HFO-1123 in a composition before transferring and filling at 90 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 11, transferring and filling was gradually carried out from a liquid side to another empty container by using a pump, and a componential composition was analyzed. Table 24 shows the results of compositional changes during the transferring and filling in a case of being adjusted to the target upper limit composition.

TABLE 24

| | HFO-1123 | | |
|---|---|---|---|
| | composition | HFO-1123 | Gap from |
| HFO-1123 | before | composition at | HFO-1123 |
| target | transferring | time of liquid | target |
| composition | and filling | disappearance | composition |
| Mass % | Mass % | Mass % | Mass % |
| 90.0 | 91.0 | 90.3 | −0.3 |
| 80.0 | 81.0 | 79.6 | 0.4 |
| 70.0 | 71.0 | 68.8 | 1.2 |
| 60.0 | 61.0 | 58.2 | 1.8 |
| 50.0 | 51.0 | 47.6 | 2.4 |
| 40.0 | 41.0 | 37.4 | 2.6 |
| 30.0 | 31.0 | 27.4 | 2.6 |
| 20.0 | 21.0 | 18.0 | 2.0 |
| 10.0 | 11.0 | 9.1 | 0.9 |

As shown in Table 24, in a case where, by setting the initial composition before the transferring and filling to the target upper limit composition, a HFO-1123 composition is allowed to be in a range of 10 to 11.6 mass % or 73.0 to 91 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−2.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{R2}) of a gap between the target upper limit composition and the initial composition at this time is shown in Table 25.

TABLE 25

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.0 | 89.8 | 89.0 | −1.3 |
| 81.0 | 80.5 | 79.0 | −0.5 |
| 73.0 | 73.0 | 71.0 | 0.0 |
| 11.6 | 11.6 | 9.6 | 0.0 |
| 11.0 | 10.9 | 9.0 | −0.1 |

From these results, compositional variations of HFO-1123 is the smallest in the target upper limit composition of 91 mass %, and, even in a case where an initial composition of HFO-1123 in the liquid phase mixed refrigerant of HFO-1123/HFO-1234yf is set to −1.3 mass % of the target upper limit composition, HFO-1123 can be kept within a range from the target upper limit composition−2.0 mass % (target lower limit composition) to the target upper limit composition from before the transferring and filling until completion of the transferring and filling.

Further, from these results, the lower limit value (y_{R2}) of the gap between the target upper limit composition and the initial composition can be represented by Expression (15) using the target upper limit composition (x).

[Math. 36]

1000y_{R2}=0.0034x³−0.8718x²+54.09x−2111.2 (15)

By setting the lower limit value (y_{R2}) based on Table 25, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{R2} to the target upper limit composition, HFO-1123 can be kept within a range from the target upper limit composition−2.0 mass % (target lower limit composition) to the target upper limit composition from before the transferring and filling until completion of the transferring and filling.

### (4-3) Example 13: Initial Filling Amount in Feeding Container is 80 Mass % of Maximum Filling Amount

A 10 L closed container was filled with HFO-1234yf and HFO-1123 in a composition before transferring and filling at 80 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 11, transferring and filling was gradually carried out from a liquid side to another empty container by using a pump, and a componential composition was analyzed. Table 26 shows the results of compositional changes during the transferring and filling in a case of being adjusted to the target upper limit composition.

TABLE 26

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.0 | 90.3 | −0.3 |
| 80.0 | 81.0 | 79.5 | 0.5 |
| 70.0 | 71.0 | 68.7 | 1.3 |
| 60.0 | 61.0 | 58.0 | 2.0 |
| 50.0 | 51.0 | 47.5 | 2.5 |
| 40.0 | 41.0 | 37.2 | 2.8 |
| 30.0 | 31.0 | 27.4 | 2.6 |
| 20.0 | 21.0 | 17.9 | 2.1 |
| 10.0 | 11.0 | 9.1 | 0.9 |

As shown in Table 26, in a case where, by setting the initial composition before the transferring and filling to the target upper limit composition, a HFO-1123 composition is allowed to be in a range of 10 to 11.0 mass % or 74.2 to 91 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−2.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{R3}) of a gap between the target upper limit composition and the initial composition at this time is shown in Table 27.

TABLE 27

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.0 | 89.8 | 89.0 | −1.2 |
| 81.0 | 80.6 | 79.0 | −0.5 |
| 74.2 | 74.2 | 72.2 | 0.0 |
| 11.0 | 11.0 | 9.0 | −0.1 |

From these results, compositional variations of HFO-1123 is the smallest in the target upper limit composition of 91 mass %, and, even in a case where an initial composition of HFO-1123 in the liquid phase mixed refrigerant of HFO-1123/HFO-1234yf is set to −1.2 mass % of the target upper limit composition, HFO-1123 can be kept within a range from the target upper limit composition−2.0 mass % (target lower limit composition) to the target upper limit composition from before the transferring and filling until completion of the transferring and filling.

Further, from these results, the lower limit value (y_{R3}) of the gap between the target upper limit composition and the initial composition can be represented by Expression (16) using the target upper limit composition (x).

[Math. 37]

1000=0.0035x³−0.9143x²+56.832x−2123.8 (16)

By setting the lower limit value (y_{R3}) based on Table 27, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{R3} to the target upper limit composition, HFO-1123 can be kept within a range from the target upper limit composition−2.0 mass % (target lower limit composition) to the target upper limit composition from before the transferring and filling until completion of the transferring and filling.

### (4-4) Example 14: Initial Filling Amount in Feeding Container is 70 Mass % of Maximum Filling Amount

A 10 L closed container was filled with HFO-1234yf and HFO-1123 in a composition before transferring and filling at 70 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 11, transferring and filling was gradually carried out from a liquid side to another empty container by using a pump, and a componential composition was analyzed. Table 28 shows the results of compositional changes during the transferring and filling in a case of being adjusted to the target upper limit composition.

TABLE 28

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.0 | 90.3 | −0.3 |
| 80.0 | 81.0 | 79.4 | 0.6 |
| 70.0 | 71.0 | 68.6 | 1.5 |
| 60.0 | 61.0 | 57.8 | 2.2 |
| 50.0 | 51.0 | 47.3 | 2.7 |
| 40.0 | 41.0 | 37.0 | 3.0 |
| 30.0 | 31.0 | 27.1 | 2.9 |
| 20.0 | 21.0 | 17.7 | 2.3 |
| 10.0 | 11.0 | 9.0 | 1.1 |

As shown in Table 28, in a case where, by setting the initial composition before the transferring and filling to the target upper limit composition, a HFO-1123 composition is allowed to be in a range of 10 to 10.3 mass % or 75.9 to 91 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−2.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{R4}) of a gap between the target upper limit composition and the initial composition at this time is shown in Table 29.

TABLE 29

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.0 | 89.9 | 89.0 | −1.2 |
| 81.0 | 80.7 | 79.0 | −0.3 |
| 75.9 | 75.9 | 73.9 | 0.0 |
| 10.3 | 10.3 | 8.3 | 0.0 |

From these results, compositional variations of HFO-1123 is the smallest in the target upper limit composition of 91 mass %, and, even in a case where an initial composition of HFO-1123 in the liquid phase mixed refrigerant of HFO-1123/HFO-1234yf is set to −1.2 mass % of the target upper limit composition, HFO-1123 can be kept within a range from the target upper limit composition−2.0 mass % (target lower limit composition) to the target upper limit composition from before the transferring and filling until completion of the transferring and filling.

Further, from these results, the lower limit value (y_{R4}) of the gap between the target upper limit composition and the initial composition can be represented by Expression (17) using the target upper limit composition (x).

[Math. 38]

1000y_{R4}=0.0041x³−1.0207x²+62.608x−2182.2 (17)

By setting the lower limit value (y_{R4}) based on Table 29, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{R4} to the target upper limit composition, HFO-1123 can be kept within a range from the target upper limit composition−2.0 mass % (target lower limit composition) to the target upper limit composition from before the transferring and filling until completion of the transferring and filling.

### (4-5) Example 15: Initial Filling Amount in Feeding Container is 60 Mass % of Maximum Filling Amount

A 10 L closed container was filled with HFO-1234yf and HFO-1123 in a composition before transferring and filling at 60 mass % of a maximum fillable amount such that a liquid phase thereof has a certain composition at 40° C., and the container was kept at 40° C. In this case, an initial composition in the liquid phase of HFO-1123 before the transferring and filling was adjusted so as to be the target upper limit composition. Next, similarly to Example 11, transferring and filling was gradually carried out from a liquid side to another empty container by using a pump, and a componential composition was analyzed. Table 30 shows the results of compositional changes during the transferring and filling in a case of being adjusted to the target upper limit composition.

TABLE 30

| | HFO-1123 | | |
|---|---|---|---|
| | composition | HFO-1123 | Gap from |
| HFO-1123 | before | composition | HFO-1123 |
| target | transferring | at time of liquid | target |
| composition | and filling | disappearance | composition |
| Mass % | Mass % | Mass % | Mass % |
| 90.0 | 91.0 | 90.2 | −0.2 |
| 80.0 | 81.0 | 79.2 | 0.8 |
| 70.0 | 71.0 | 68.3 | 1.7 |
| 60.0 | 61.0 | 57.5 | 2.5 |
| 50.0 | 51.0 | 46.9 | 3.1 |
| 40.0 | 41.0 | 36.7 | 3.3 |
| 30.0 | 31.0 | 26.9 | 3.1 |
| 20.0 | 21.0 | 17.6 | 2.4 |
| 10.0 | 11.0 | 8.8 | 1.2 |

As shown in Table 30, in a case where, by setting the initial composition before the transferring and filling to the target upper limit composition, a HFO-1123 composition is allowed to be in a range of 77.9 to 91 mass % in a liquid phase mixed refrigerant of HFO-1123/HFO-1234yf in a composition thereof from beginning of filling (before the transferring and filling) until disappearance of liquid (until completion of the transferring and filling), HFO-1123 can be kept within a range from the target upper limit composition−2.0 mass % (target lower limit composition) to the target upper limit composition.

Further, a composition of HFO-1123 in a liquid phase mixed refrigerant of HFO-1123/HFO-1234yf before the transferring and filling was obtained, so that the composition of HFO-1123 allows a composition of HFO-1123 at the time of completion of the transferring and filling to become the target lower limit composition. A lower limit value (y_{R5}) of a gap between the target upper limit composition and the initial composition at this time is shown in Table 31.

TABLE 31

| | HFO-1123 | | Lower limit value |
|---|---|---|---|
| HFO-1123 | composition | HFO-1123 | (y) of gap from |
| target | before | composition | HFO-1123 |
| upper limit | transferring | at time of liquid | target upper limit |
| composition | and filling | disappearance | composition |
| Mass % | Mass % | Mass % | Mass % |
| 91.0 | 90.0 | 89.0 | −1.1 |
| 81.0 | 80.8 | 79.0 | −0.2 |
| 77.9 | 77.9 | 75.9 | 0.0 |

From these results, compositional variations of HFO-1123 is the smallest in the target upper limit composition of 91 mass %, and, even in a case where an initial composition of HFO-1123 in the liquid phase mixed refrigerant of HFO-1123/HFO-1234yf is set to −1.1 mass % of the target upper limit composition, HFO-1123 can be kept within a range from the target upper limit composition−2.0 mass % (target lower limit composition) to the target upper limit composition from before the transferring and filling until completion of the transferring and filling.

Further, from these results, the lower limit value (y_{R}5) of the gap between the target upper limit composition and the initial composition can be represented by Expression (18) using the target upper limit composition (x).

[Math. 39]

10000y_{R5}=0.0045x³−1.103x²+66.683x−2160 (18)

By setting the lower limit value (y_{R5}) based on Table 31, it is possible to keep all compositions from start of the transferring and filling until completion of the transferring and filling within the target lower limit composition to the target upper limit composition for any target upper limit composition.

Therefore, by setting the initial composition of HFO-1123 in the liquid phase mixed refrigerant of HFO-1123/HFO-1234yf to the target upper limit composition+y_{R5} to the target upper limit composition, HFO-1123 can be kept within a range from the target upper limit composition−2.0 mass % (target lower limit composition) to the target upper limit composition from before the transferring and filling until completion of the transferring and filling.

### (5) Consideration

As is clear from the results of the above examples, according to the filling method for a mixed refrigerant of the present invention, there has been provided a new filling method of a non-azeotropic mixed refrigerant which allows compositional changes due to transferring and filling to be kept within a certain range with respect to an intended composition from before the transferring and filling until completion of the transferring and filling, and enables use of an entire amount of a liquid phase, as compared with a case where transferring and filling is carried out without taking any measures.

By carrying out the method of the present invention, it is meaningful that compositional changes occurring during transferring and filling of a non-azeotropic HFO-1234yf/HFO-1123 mixed refrigerant used as a working fluid for a vapor compression type refrigeration cycle can be kept within a range that does not cause impairment of refrigerant capability.

While the present invention has been described in detail and with reference to specific embodiments, it will be apparent to those skilled in the art that various changes and modifications can be made without departing from the spirit and scope of the present invention. The present application is based on Japanese patent application (Japanese Patent Application No. 2016-7438) filed on Jan. 18, 2016, the contents of which are incorporated herein by reference.

1. A filling method for a mixed refrigerant, in which in a case of transferring and filling a mixed refrigerant that contains trifluoroethylene and 2,3,3,3-tetrafluoropropene and in which the trifluoroethylene is present in an amount of 10 to 92 mass % in a liquid phase, with respect to a total 100 mass % of the trifluoroethylene and the 2,3,3,3-tetrafluoropropene, in a liquid from a feeding container to a target container and equipment,
in order to keep a liquid phase mixing ratio of the trifluoroethylene in the mixed refrigerant in the feeding container from start of the transferring and filling until completion thereof within a range from a target upper limit composition (x) of the trifluoroethylene to the target upper limit composition (x)−4.0 mass % (target lower limit composition),
a liquid phase mixing ratio (initial composition) of the trifluoroethylene in the mixed refrigerant in the feeding container immediately before the transferring and filling is set to x+y_{P} (minimum value) to x % (target upper limit composition);
a: initial filling amount (mass %) in feeding container;
x: target upper limit composition (10≤x≤92, except for a range where y_{P}>0);
y_{P}: lower limit value of gap from target upper limit composition in initial composition, which is a value represented by expression (A):
1000y_{P}=L_{P}x³+M_{P}x²+N_{P}x+P_{P}
L_{P}=−0.00003a+0.0211
M_{P}=0.0119a−5.313
N_{P}=−0.9678a+334.84
P_{P}=2.979a−4879.3 (A)

2. A filling method for a mixed refrigerant, in which in a case of transferring and filling a mixed refrigerant that contains trifluoroethylene and 2,3,3,3-tetrafluoropropene and in which the trifluoroethylene is present in an amount of 10 to 91.5 mass %, in a liquid phase, with respect to a total 100 mass % of the trifluoroethylene and the 2,3,3,3-tetrafluoropropene, in a liquid from a feeding container to a target container and equipment,
in order to keep a liquid phase mixing ratio of the trifluoroethylene in the mixed refrigerant in the feeding container from start of the transferring and filling until completion thereof within a range from a target upper limit composition (x) of the trifluoroethylene to the target upper limit composition (x)−3.0 mass % (target lower limit composition),
a liquid phase mixing ratio (initial composition) of the trifluoroethylene in the mixed refrigerant in the feeding container immediately before the transferring and filling is set to x+y_{Q} (minimum value) to x % (target upper limit composition);
a: initial filling amount (mass %) in feeding container;
x: target upper limit composition (10≤x≤91.5, except for a range where y_{Q}>0);
y_{Q}: lower limit value of gap from target upper limit composition in initial composition, which is a value represented by expression (B):
1000y_{Q}=L_{Q}x³+M_{Q}x²+N_{Q}x+P_{Q}
L_{Q}=−0.0001a−0.0276
M_{Q}=0.0262a−6.2574
N_{Q}=−1.5203a+364.04
P_{Q}=5.928a−3797.8 (B)

3. A filling method for a mixed refrigerant, in which in a case of transferring and filling a mixed refrigerant that contains trifluoroethylene and 2,3,3,3-tetrafluoropropene and in which the trifluoroethylene is present in an amount of 10 to 91 mass %, in a liquid phase, with respect to a total 100 mass % of the trifluoroethylene and the 2,3,3,3-tetrafluoropropene, in a liquid from a feeding container to a target container and equipment,
in order to keep a liquid phase mixing ratio of the trifluoroethylene in the mixed refrigerant in the feeding container from start of the transferring and filling until completion thereof within a range from a target upper limit composition (x) of the trifluoroethylene to the target upper limit composition (x)−2.0 mass % (target lower limit composition),
a liquid phase mixing ratio (initial composition) of the trifluoroethylene in the mixed refrigerant in the feeding container immediately before the transferring and filling is set to x+y_{R} (minimum value) to x % (target upper limit composition);
a: initial filling amount (mass %) in feeding container;
x: target upper limit composition (10≤x≤91, except for a range where y_{R}>0);
y_{R}: lower limit value of gap from target upper limit composition in initial composition, which is a value represented by expression (C):
1000y_{R}=L_{R}x³+M_{R}x²+N_{R}x+P_{R}
L_{R}=−0.00005a+0.0223
M_{R}=0.0159a−5.5003
N_{R}=−1.0799a+324.91
P_{R}=2.771a−2333.7 (C)
